(19) United States
(12) Patent Application Publication
(10) Pub. No.: US 2026/0107060 A1
(43) Pub. Date: Apr. 16, 2026

(54) IMAGE CAPTURING APPARATUS, CONTROL METHOD FOR IMAGE CAPTURING APPARATUS, AND STORAGE MEDIUM HAVING A UI SUITABLE FOR OBTAINING IMAGES FOR AUTHENTICATION

(71) Applicant: CANON KABUSHIKI KAISHA, Tokyo (JP)

(72) Inventors: TAKATO KIMURA, Kanagawa (JP); KUNIHIKO YAMAKAWA, Kanagawa (JP); HIROSHI SATO, Kanagawa (JP)

(21) Appl. No.: 19/354,696

(22) Filed: Oct. 9, 2025

(30) Foreign Application Priority Data
Oct. 15, 2024 (JP) 2024-179992

(51) Int. Cl. H04N 23/60; G06V 40/18; G06V 40/60; H04N 23/63

(52) U.S. Cl. CPC H04N 23/64; G06V 40/197; G06V 40/67; H04N 23/635

(57) ABSTRACT

An image capturing apparatus includes a first authentication unit configured to perform authentication of the user based on an eye image (authentication image) before capturing of a subject image based on an operation performed by a user, a second authentication unit configured to perform authentication of the user based on the eye image during capturing of the subject image, and an information presentation unit configured to present, to the user, first presentation information including guidance information for guiding at least one of a position or direction of the eye of the user during capturing of the eye image when authentication of the user is performed by the first authentication unit and to present, to the user, during capturing of the eye image, second presentation information related to authentication processing by the second authentication unit when authentication of the user is performed by the second authentication unit.

### BACKGROUND

### Field of the Technology

The present disclosure relates to an image capturing apparatus, a control method for an image capturing apparatus, and a storage medium.

### Description of the Related Art

Some image capturing apparatuses which are used while being gripped in a hand may be configured to perform authentication of the user by comparing a preliminarily registered image with an image obtained by an image capturing unit incorporated in the image capturing apparatus and configured to capture an image of the user. Such authentication is completed only by capturing an image of the user with the image capturing unit and is, therefore, highly convenient, and, until now, has been used for use cases that are based on the user performing image capturing of an image that is suitable for authentication, such as the case of a login function to the image capturing apparatus.

To correctly perform authentication using images, it is necessary that a person shown in a preliminarily registered image (hereinafter referred to as a “registered image” as needed) and a person shown in an image captured by an image capturing unit (hereinafter referred to as an “authentication image” as needed) are determined to be the same person. Therefore, heretofore, a method has been devised of performing user authentication using iris recognition with the irises of eyes and causing the respective appearances of the irises of eyes shown in the registered image and the authentication image to resemble each other. Japanese Patent Laid-Open No. 2015-170099 describes a technique which acquires an authentication image facilitating iris recognition by varying a user interface (UI) to be displayed, based on the size of a pupil in the authentication image or the brightness of an environment occurring at the time of acquisition of an authentication image being an eye image of the user.

If there is a big change in appearance between a registered image and an authentication image, the accuracy of user authentication decreases. In conventional techniques, there is an issue in which it is difficult to acquire an authentication image in such a manner that reduces a change in appearance between the authentication image and a registered image while ensuring usability at the time of image capturing using an image capturing apparatus.

### SUMMARY

The present disclosure is made in view of the above-mentioned issue and is directed to enabling the acquisition of an authentication image in such a manner that reduces a change in appearance between the authentication image and a registered image while ensuring usability at the time of image capturing using an image capturing apparatus.

According to an aspect of the present disclosure, an image capturing apparatus includes at least one processor, and at least one memory having stored thereon instructions, which, when executed by the at least one processor, cause the image capturing apparatus to: capture a subject image based on an operation performed by a user, capture an eye image including an eye of the user as an authentication image, perform authentication of the user based on the eye image before capturing of the subject image, perform authentication of the user based on the eye image during capturing of the subject image, present, to the user, first presentation information including guidance information for guiding at least one of a position or direction of the eye of the user during capturing of the eye image when authentication of the user is performed before capturing of the subject image, and present, to the user, during capturing of the eye image, second presentation information related to authentication processing for the user when authentication of the user is performed during capturing of the subject image.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams each illustrating an example of an exterior appearance of an image capturing apparatus according to a first embodiment.

FIG. 2 is a diagram illustrating an example of an internal mechanism of the image capturing apparatus according to the first embodiment.

FIG. 3 is a diagram illustrating an example of an electrical configuration of the image capturing apparatus according to the first embodiment.

FIGS. 4A, 4B, 4C, and 4D are diagrams illustrating examples of display screens of a display device of the image capturing apparatus according to the first embodiment.

FIG. 5A is a diagram illustrating an example of a functional configuration of the image capturing apparatus according to the first embodiment.

FIG. 5B is a diagram illustrating an example of one of various tables that a registration data management unit illustrated in FIG. 5A manages in the first embodiment.

FIG. 5C is a diagram illustrating an example of one of various tables that the registration data management unit illustrated in FIG. 5A manages in the first embodiment.

FIG. 5D is a diagram illustrating an example of one of various tables that the registration data management unit illustrated in FIG. 5A manages in the first embodiment.

FIG. 5E is a diagram illustrating an example of an authentication state table that an authentication state management unit illustrated in FIG. 5A manages in the first embodiment.

FIG. 6 is a flowchart illustrating an example of a detailed registration processing procedure in a control method for the image capturing apparatus according to the first embodiment.

FIG. 7 is a flowchart illustrating an example of a detailed processing procedure for acquisition of an eye image in step S604 illustrated in FIG. 6.

FIG. 8 is a flowchart illustrating an example of a detailed first authentication processing procedure in the control method for the image capturing apparatus according to the first embodiment.

FIG. 9 is a flowchart illustrating an example of a detailed processing procedure for the time of failure of the acquisition of an eye image in step S805 illustrated in FIG. 8.

FIG. 10 is a flowchart illustrating an example of a detailed comparison processing procedure in step S806 illustrated in FIG. 8.

FIG. 11 is a flowchart illustrating an example of a detailed processing procedure for the time of success of authentication in step S808 illustrated in FIG. 8.

FIG. 12 is a flowchart illustrating an example of a detailed processing procedure for the time of failure of authentication in step S809 illustrated in FIG. 8.

FIG. 13 is a diagram illustrating an example of a display screen that is displayed in display processing in step S901 illustrated in FIG. 9.

FIGS. 14A and 14B are diagrams each illustrating an example of a display screen that is displayed in display processing in step S903 illustrated in FIG. 9.

FIG. 15 is a diagram illustrating an example of a display screen that is displayed in display processing in step S1103 illustrated in FIG. 11.

FIG. 16 is a diagram illustrating an example of a display screen that is displayed in display processing in step S1203 illustrated in FIG. 12.

FIG. 17 is a flowchart illustrating an example of a detailed second authentication processing procedure in the control method for the image capturing apparatus according to the first embodiment.

FIG. 18 is a flowchart illustrating an example of a detailed comparison processing procedure in step S1705 illustrated in FIG. 17.

FIG. 19 is a flowchart illustrating an example of a detailed processing procedure for the time of success of authentication in step S1707 illustrated in FIG. 17.

FIG. 20 is a flowchart illustrating an example of a detailed processing procedure for the time of failure of authentication in step S1709 illustrated in FIG. 17.

FIG. 21 is a diagram illustrating an example of a display screen that is displayed in display processing in step S1704 illustrated in FIG. 17.

FIG. 22 is a diagram illustrating an example of a display screen that is displayed in display processing in step S1902 illustrated in FIG. 19.

FIG. 23 is a diagram illustrating an example of a display screen that is displayed in display processing in step S2002 illustrated in FIG. 20.

FIG. 24 is a diagram illustrating an example of a display screen that is displayed in display processing in step S1205 illustrated in FIG. 12.

FIG. 25 is a diagram illustrating an example of a display screen that is displayed in display processing in step S2004 illustrated in FIG. 20.

FIG. 26 is a diagram illustrating an example of a display screen for displaying guidance information included in first presentation information in a first modification example of the first embodiment.

FIG. 27 is a diagram illustrating an example of a display screen for displaying guidance information included in first presentation information in the first modification example of the first embodiment.

FIGS. 28A and 28B are diagrams each illustrating an example of a display screen for displaying guidance information included in first presentation information in a second modification example of the first embodiment.

FIG. 29 is a diagram illustrating an example of a display screen for displaying guidance information included in first presentation information in a third modification example of the first embodiment.

FIGS. 30A and 30B are diagrams each illustrating an example of a display screen for displaying guidance information included in first presentation information in a fifth modification example of the first embodiment.

FIGS. 31A and 31B are diagrams each illustrating an example of a display screen for displaying guidance information included in first presentation information in a sixth modification example of the first embodiment.

FIG. 32 is a flowchart illustrating an example of a detailed processing procedure for the time of failure of authentication in step S1709 illustrated in FIG. 17 in a second embodiment.

FIGS. 33A and 33B are diagrams each illustrating an example of a display screen that is displayed in display processing in step S3203 illustrated in FIG. 32.

FIGS. 34A and 34B are diagrams each illustrating an example of a display screen that is displayed in display processing in step S3203 illustrated in FIG. 32 in a first modification example of the second embodiment.

FIGS. 35A and 35B are diagrams each illustrating an example of a display screen that is displayed in display processing in step S3203 illustrated in FIG. 32 in a second modification example of the second embodiment.

FIGS. 36A and 36B are diagrams each illustrating an example of a display screen that is displayed in display processing in step S3203 illustrated in FIG. 32 in the second modification example of the second embodiment.

FIG. 37 is a diagram illustrating an example of a display screen for displaying guidance information included in second presentation information in a third modification example of the second embodiment.

FIGS. 38A and 38B are diagrams each illustrating an example of a display screen for displaying guidance information included in second presentation information in a fourth modification example of the second embodiment.

FIG. 39 is a diagram illustrating an example of a display screen for displaying guidance information included in second presentation information in a fifth modification example of the second embodiment.

FIGS. 40A and 40B are diagrams each illustrating an example of a display screen for displaying guidance information included in second presentation information in a seventh modification example of the second embodiment.

FIG. 41 is a diagram illustrating an example of a display screen for displaying guidance information included in second presentation information in an eighth modification example of the second embodiment.

### DESCRIPTION OF THE EMBODIMENTS

Various embodiments, features, and aspects of the present disclosure will be described in detail below with reference to the drawings.

### First Embodiment

First, a first embodiment is described.

In the first embodiment, with regard to an image capturing apparatus having a first eyeball authentication function and a second eyeball authentication function for the user, a configuration for acquiring, as an authentication image, an eye image of the user suitable for each authentication is described. Here, the first eyeball authentication (hereinafter referred to simply as “first authentication”) is an authentication that is performed when the user starts the use of the image capturing apparatus and before the image capturing apparatus captures a subject image based on an operation performed by the user. The first authentication is an authentication that is required to be rigorous.

On the other hand, the second eyeball authentication (hereinafter referred to simply as “second authentication”) is an authentication that is performed after execution of the above-mentioned first authentication and when the image capturing apparatus captures a subject image based on an operation performed by the user (for example, an authentication that is performed in conformity with the timing of when the user has pressed the shutter button). The second authentication is an authentication that avoids hindering an image capturing operation of the user as much as possible as compared with the above-mentioned first authentication.

### Configuration of Image Capturing Apparatus (Camera)

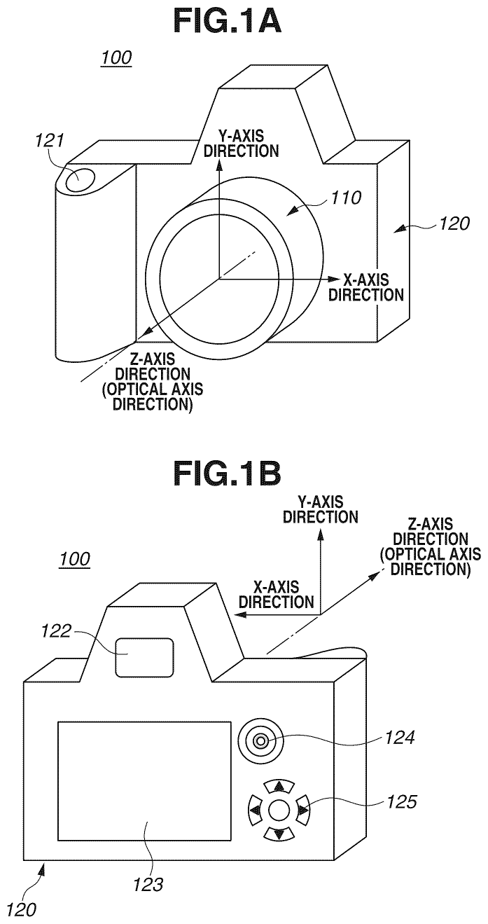

FIGS. 1A and 1B are diagrams each illustrating an example of an exterior appearance of an image capturing apparatus 100 according to the first embodiment. Specifically, as the image capturing apparatus 100 according to the first embodiment, for example, a lens-interchangeable digital still camera can be used. FIG. 1A is a front perspective view illustrating an example of an exterior appearance of the image capturing apparatus 100 according to the first embodiment. FIG. 1B is a rear perspective view illustrating an example of an exterior appearance of the image capturing apparatus 100 according to the first embodiment. In FIGS. 1A and 1B, the same constituent elements are assigned the respective same reference characters. Moreover, in FIGS. 1A and 1B, an XYZ coordinate system in which the optical axis direction of the image capturing apparatus 100 is defined as a Z-axis direction and two directions perpendicular to the Z-axis direction and perpendicular to each other are defined as an X-axis direction and a Y-axis direction is illustrated.

As illustrated in FIG. 1A, the image capturing apparatus 100 includes a photographic lens unit 110 and a camera body 120. On the front side of the camera body 120, a release button 121 serving as an operation member which receives and accepts an image capturing operation performed by the user (a person who performs image capturing or a photographer) is arranged.

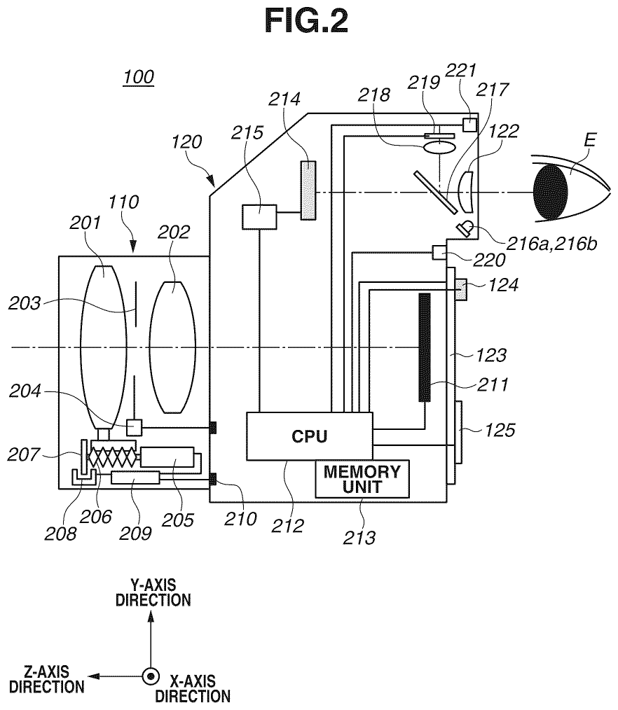

As illustrated in FIG. 1B, on the back side of the camera body 120, an eyepiece lens 122 (viewfinder), into which the user looks to view a display device (a display device 214 illustrated in FIG. 2 described below) included inside the camera body 120 is arranged. Additionally, on the back side of the camera body 120, operation members 123 to 125, which receive and accept various operations performed by the user, are also arranged. For example, the operation member 123 is a touch panel that receives and accepts a touch operation, the operation member 124 is an operation lever that is able to be pushed down in the respective directions, and the operation member 125 includes four-way keys that are able to be pushed in the respective four directions. The operation member 123, which is a touch panel, is provided with a display panel (for example, a liquid crystal panel), and the display panel constitutes a back side display in the image capturing apparatus 100. Moreover, the operation member 123, which is a touch panel, has the function of displaying various images on the display panel.

FIG. 2 is a diagram illustrating an example of an internal mechanism of the image capturing apparatus 100 according to the first embodiment. Specifically, FIG. 2 illustrates a sectional view obtained by cutting the image capturing apparatus 100 with a YZ plane formed by the Y-axis direction and the Z-axis direction illustrated in FIG. 1A. In FIG. 2, the same constituent elements as the constituent elements illustrated in FIGS. 1A and 1B are assigned the respective same reference characters as those in FIGS. 1A and 1B and the detailed description thereof is omitted here. Moreover, in FIG. 2, an XYZ coordinate system corresponding to the XYZ coordinate system illustrated in FIGS. 1A and 1B is illustrated.

The photographic lens unit 110 includes, as an internal mechanism, lenses 201 and 202, a diaphragm 203, a diaphragm driving unit 204, a lens driving motor 205, a lens driving member 206, a pulse plate 207, a photo coupler 208, a focusing circuit 209, and mount contacts 210.

Here, the lens driving member 206 includes drive gears. The photo coupler 208 detects the rotation of the pulse plate 207, which rotates in conjunction with the lens driving member 206, and communicates the detected rotation to the focusing circuit 209. The focusing circuit 209 drives the lens driving motor 205 based on information communicated from the photo coupler 208 and information communicated from the camera body 120 (information about a lens driving amount) and thus moves the lens 201 to change a focusing position. The mount contacts 210 serve as an interface between the photographic lens unit 110 and the camera body 120. Furthermore, while, in FIG. 2, only two lenses, 201 and 202, are illustrated for the sake of simplicity, more than two lenses may be included inside the photographic lens unit 110.

The camera body 120 includes, as an internal mechanism, an image sensor 211, a central processing unit (CPU) 212, a memory unit 213, a display device 214, a display device driving circuit 215, light sources 216a and 216b, a beam splitter 217, a light receiving lens 218, and an eye image sensor 219. Additionally, the camera body 120 further includes, as an internal mechanism, a loudspeaker 220 and an eyepiece sensor 221.

The image sensor 211 is arranged on a planned imaging plane of the photographic lens unit 110. The image sensor 211 is a component portion serving as an example of a first image capturing unit which captures (photographs) the image of a subject based on an operation performed by the user to acquire a subject image. The CPU 212 is a central processor of a microcomputer, which controls the entire operation of the image capturing apparatus 100 and performs various processing operations. The memory unit 213 stores various pieces of information and, for example, programs that the CPU 212 executes when performing various processing operations. For example, the memory unit 213 stores a subject image captured (photographed) by the image sensor 211. The display device 214 displays various pieces of information on a screen (display surface) of the display device 214. For example, the display device 214 is a liquid crystal panel and displays a captured image (subject image) on the screen. The display device driving circuit 215 drives the display device 214. The eye (eyeball) E of the user is able to view the screen of the display device 214 through the eyepiece lens 122.

The light sources 216a and 216b are light sources that are conventionally used in a single-lens reflex camera to detect the line of sight of the eye (eyeball) E based on a relationship between a reflection image caused by the corneal reflection of light (a corneal reflection image) and the pupil of the eye (eyeball) E. Specifically, the light sources 216a and 216b are light sources that illuminate the eye (eyeball) E of the user who looks in the viewfinder (eyepiece lens 122). For example, the light sources 216a and 216b are infrared light-emitting diodes that emit invisible infrared light to the eye (eyeball) E of the user and are arranged in the vicinity of the eyepiece lens 122. An optical image of the eye (eyeball) E illuminated by the light sources 216a and 216b (an eye optical image; an optical image formed by light emitted from the light sources 216a and 216b and then reflected from the eye (eyeball) E) passes through the eyepiece lens 122 and is then reflected by the beam splitter 217. Then, the eye optical image is focused by the light receiving lens 218 on the eye image sensor 219, in which a plurality of photoelectric conversion elements (for example, charge-coupled device (CCD) sensors or complementary metal-oxide semiconductor (CMOS) sensors) are two-dimensionally arranged. The light receiving lens 218 brings the pupil of the eye (eyeball) E of the user and the eye image sensor 219 into a conjugate image formation relationship. Performing line-of-sight detection processing enables detecting the line of sight of the eye (eyeball) E based on the position of a corneal reflection image in an eye optical image focused on the eye image sensor 219. For example, information about the line of sight able to be obtained includes at least one of information indicating the direction of the line of sight or information indicating a point of view in the screen of the display device 214 (the position where the line of sight is directed). The point of view can be regarded as the position that the user is viewing or as the line-of-sight position. Moreover, the eye image sensor 219 is a component portion serving as an example of a second image capturing unit, which captures (photographs) an eye image containing the eye (eyeball) E of the user as an authentication image.

The loudspeaker 220 is a component portion serving as an example of a sound output unit that reproduces and outputs a shutter sound or an audio guide. The eyepiece sensor 221 is a component portion that acquires eye access information about the eye (eyeball) E of the user as the state of the eye (eyeball) E of the user. For example, the eyepiece sensor 221 measures, as an example of eye access information, the eye access distance of the user, which is a distance from the eyepiece sensor 221 to the eye (eyeball) E of the user and thus detects whether the user is looking in the viewfinder (eyepiece lens 122).

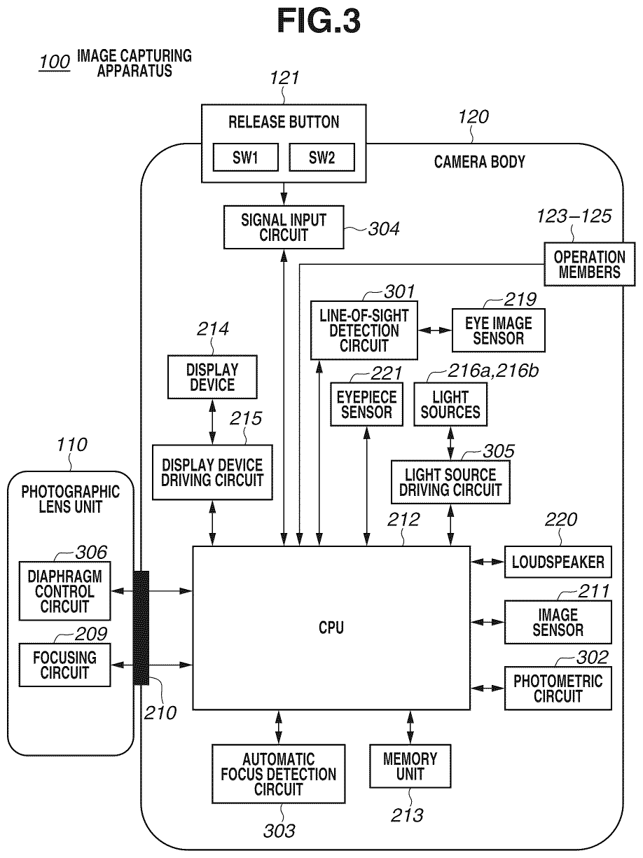

FIG. 3 is a diagram illustrating an example of an electrical configuration of the image capturing apparatus 100 according to the first embodiment. In FIG. 3, the same constituent elements as the respective constituent elements illustrated in FIGS. 1A and 1B and FIG. 2 are assigned the respective same reference characters as those in FIGS. 1A and 1B and FIG. 2 and the detailed description thereof is omitted here.

The photographic lens unit 110 includes, as an electrical configuration, the focusing circuit 209 illustrated in FIG. 2 and a diaphragm control circuit 306.

The camera body 120 includes, as an electrical configuration, the release button 121 and the operation members 123 to 125 each illustrated in FIGS. 1A and 1B. Moreover, the camera body 120 includes, as an electrical configuration, the image sensor 211, the CPU 212, the memory unit 213, the display device 214, the display device driving circuit 215, the light sources 216a and 216b, the eye image sensor 219, the loudspeaker 220, and the eyepiece sensor 221 each illustrated in FIG. 2. Additionally, as illustrated in FIG. 3, the camera body 120 includes, as an electrical configuration, a line-of-sight detection circuit 301, a photometric circuit 302, an automatic focus detection circuit 303, a signal input circuit 304, and a light source driving circuit 305.

As illustrated in FIG. 3, the CPU 212 is connected to the line-of-sight detection circuit 301, the photometric circuit 302, the automatic focus detection circuit 303, the signal input circuit 304, and the light source driving circuit 305. Additionally, as illustrated in FIG. 3, the CPU 212 is connected to the image sensor 211, the memory unit 213, the display device driving circuit 215, the loudspeaker 220, the eyepiece sensor 221, and the operation members 123 to 125. Moreover, the CPU 212 transmits, via the mount contacts 210, signals to the focusing circuit 209, which is arranged inside the photographic lens unit 110, and the diaphragm control circuit 306, which is included in the diaphragm driving unit 204 arranged inside the photographic lens unit 110. The memory unit 213, which is attached to the CPU 212, has a storage function of storing, for example, captured image signals received from the image sensor 211 and the eye image sensor 219.

The line-of-sight detection circuit 301 performs analog-to-digital (A/D) conversion of the output of the eye image sensor 219 (an eye image obtained by capturing the image of an eye (eyeball) E of the user) in a state in which an eye optical image is focused on the eye image sensor 219, and then transmits a result of the A/D conversion to the CPU 212. The CPU 212 extracts, from the eye image, characteristic points required for line-of-sight detection according to line-of-sight detection processing and thus detects the line of sight of the user based on the positions of the characteristic points.

The photometric circuit 302 performs predetermined processing operations (for example, amplification, logarithmic compression, and A/D conversion) on a signal obtained by the image sensor 211, which also serves as a light metering sensor, such as a luminance signal corresponding to the brightness of a subject field, and then sends results of the processing operations as subject field luminance information to the CPU 212.

The automatic focus detection circuit 303 performs A/D conversion of signals received from a plurality of detection elements (a plurality of pixels), which is used for phase difference detection, included in the image sensor 211 and sends the signals subjected to A/D conversion to the CPU 212. The CPU 212 calculates a distance from the image capturing apparatus 100 to a subject corresponding to each focus detection point. This is a known technique referred to as imaging plane phase-difference autofocus (AF).

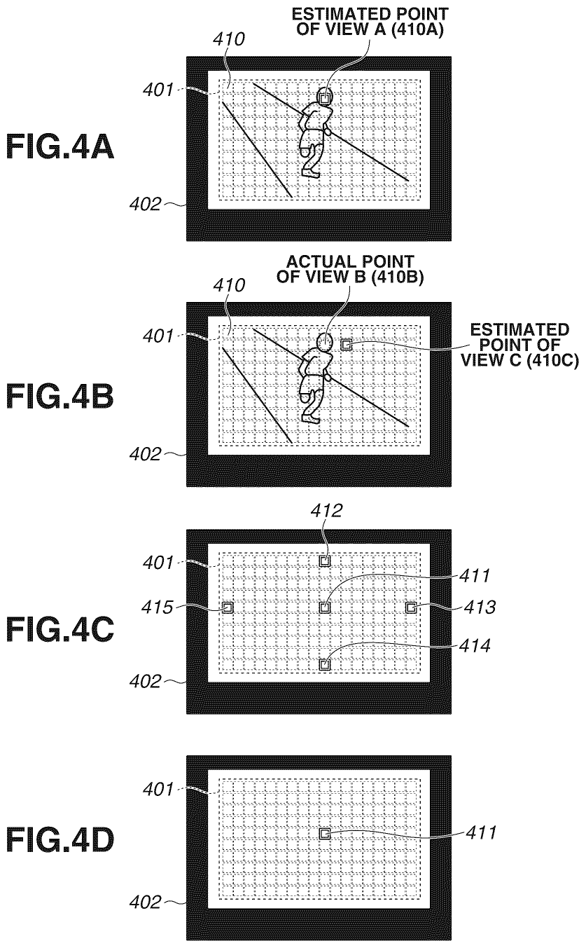

FIGS. 4A, 4B, 4C, and 4D are diagrams illustrating examples of display screens of the display device 214 in the first embodiment.

As an example, in the first embodiment, the focus detection points described above with regard to the automatic focus detection circuit 303 are assumed to be arranged at the respective 180 portions on the imaging plane corresponding to 180 portions shown on the screen (intra-viewfinder field of view) of the display device 214, illustrated in FIG. 4A. FIG. 4A illustrates a state in which the display device 214 has operated (a state in which the display device 214 has displayed an image), and the intra-viewfinder field of view includes a focus detection area 401, a field-of-view mask 402, and 180 distance measuring point indexes 410 contained in the focus detection area 401. Each distance measuring point index 410 illustrated in FIG. 4A is displayed in superimposition on a through-image (a live view image) displayed on the display device 214 in such a way as to be displayed at a position corresponding to an applicable focus detection point on the imaging plane. Moreover, among 180 distance measuring point indexes 410 illustrated in FIG. 4A, a distance measuring point index 410A corresponding to a current point of view A (estimated position) is displayed while being highlighted by, for example, a frame. Moreover, the point of view may not be estimated with a high degree of accuracy, due to a factor such as an individual difference in the shape of the eye E of a person. Specifically, as illustrated in FIG. 4B, a deviation may occur between an actual point of view B (410B) and an estimated point of view C (410C).

Here, the description refers back to FIG. 3 again.

To the signal input circuit 304, a switch SW1 and a switch SW2 of the release button 121 are connected. The switch SW1 is a switch which is turned on by the first stroke of the release button 121 to start an image capturing preparation operation (for example, light metering and distance measuring) of the image capturing apparatus 100. The switch SW2 is a switch which is turned on by the second stroke of the release button 121 to start an image capturing operation of the image capturing apparatus 100. When an ON signal output from the switch SW1 or SW2 of the release button 121 has been input to the signal input circuit 304, the signal input circuit 304 transmits the input ON signal to the CPU 212. Here, in a case where the switch SW1 of the release button 121 has been turned on, the line-of-sight detection processing for the user can be started.

The light source driving circuit 305 drives the light sources 216a and 216b.

Additionally, when the user has operated the operation members 123 to 125, the operation members 123 to 125 output operation signals corresponding to the respective operations performed by the user to the CPU 212. Then, the CPU 212 performs processing (control) operations corresponding to the respective operation signals. For example, the CPU 212 moves a selection frame for a displayed menu according to the applicable operation signal.

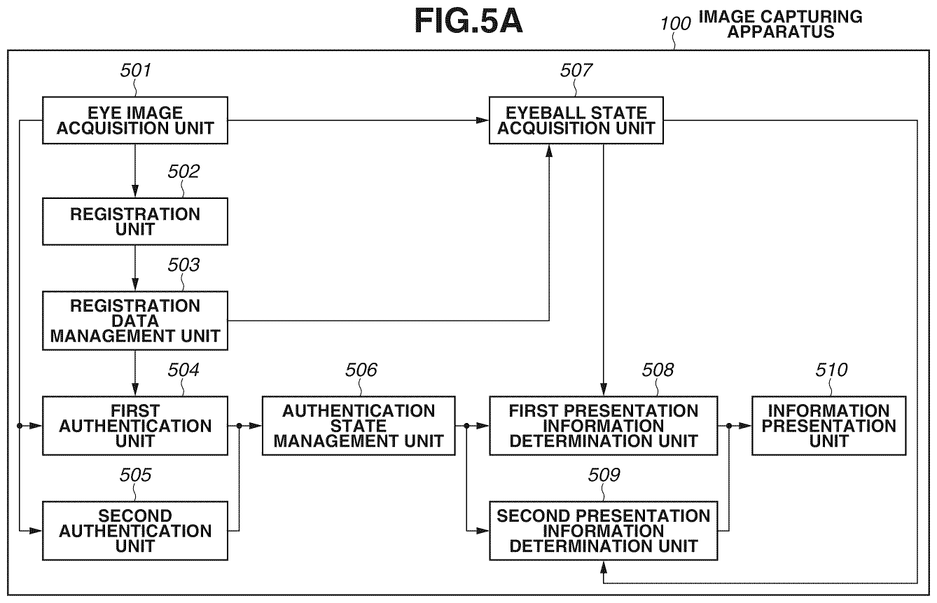

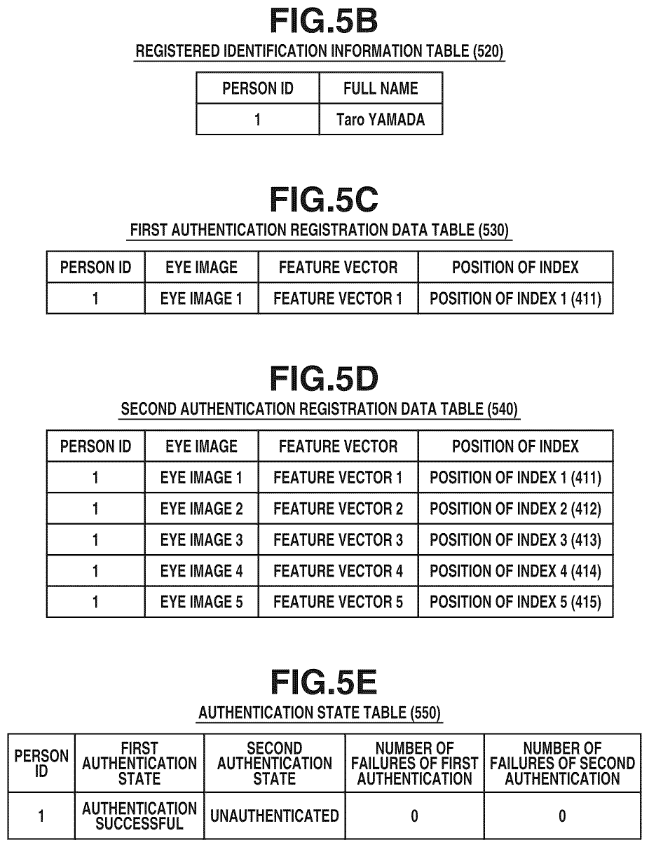

FIG. 5A is a diagram illustrating an example of a functional configuration of the image capturing apparatus 100 according to the first embodiment. The image capturing apparatus 100 is an image capturing apparatus that performs authentication of the user. The image capturing apparatus 100 includes, as a functional configuration, an eye image acquisition unit 501, a registration unit 502, a registration data management unit 503, a first authentication unit 504, a second authentication unit 505, and an authentication state management unit 506. Additionally, the image capturing apparatus 100 further includes, as a functional configuration, an eyeball state acquisition unit 507, a first presentation information determination unit 508, a second presentation information determination unit 509, and an information presentation unit 510. The respective functional constituent elements (501 to 510) illustrated in FIG. 5A are, for example, implemented by the CPU 212 illustrated in FIG. 2 and FIG. 3 executing a program stored in the memory unit 213 illustrated in FIG. 2 and FIG. 3.

In the first embodiment, the image capturing apparatus 100 performs personal authentication for the user to authenticate whether the user is a registered person based on the eye (eyeball) E of a user who looks in the viewfinder (eyepiece lens 122). Particularly, the image capturing apparatus 100 performs first authentication before the user performs image capturing of a subject with use of the image capturing apparatus 100 and performs second authentication when the user performs image capturing of a subject with use of the image capturing apparatus 100 (for example, at the time of image capturing). Then, in the first embodiment, the image capturing apparatus 100 stores results of the first authentication and second authentication together with a captured image.

The eye image acquisition unit 501 is configured to acquire an eye image including the eye (eyeball) E of a user who looks in the viewfinder (eyepiece lens 122). Specifically, the eye image acquisition unit 501 acquires an eye image (an eye image signal; an electrical signal representing an eye image) from the eye image sensor 219 illustrated in FIG. 3 via the line-of-sight detection circuit 301. In the first embodiment, in the case of registration processing for a registered user, the eye image acquisition unit 501 acquires an eye image serving as a registered image, and, in the case of authentication processing for an authentication target user, the eye image acquisition unit 501 acquires an eye image serving as an authentication image.

The registration unit 502 is configured to create data to be registered with the registration data management unit 503, based on an eye image of the registered user acquired by the eye image acquisition unit 501.

The registration data management unit 503 is configured to manage authentication registration information about the user who is allowed to use the image capturing apparatus 100. Specifically, the registration data management unit 503 retains, in the memory unit 213, an eye image of the registered user serving as a preliminarily acquired registered eye image, a feature vector calculated from the eye image of the registered user, and the position of an index corresponding to the calculated feature vector in association with the full name and person identification (ID) of the registered user. In the first embodiment, the registered user inputs the full name thereof at the beginning of registration processing and the registration data management unit 503 manages, by a table, the input full name of the registered user (and the person ID) in association with the registered data.

FIGS. 5B, 5C, and 5D are diagrams illustrating examples of various tables that the registration data management unit 503 illustrated in FIG. 5A manages in the first embodiment. Specifically, a registered identification information table 520 illustrated in FIG. 5B is a table in which a person ID and the full name of a registered user are associated with each other. A first authentication registration data table 530 illustrated in FIG. 5C is a table in which a person ID, an eye image of the registered user which is used in the first authentication unit 504, a feature vector which is used in the first authentication unit 504, and the position of an index corresponding to the feature vector are associated with each other. A second authentication registration data table 540 illustrated in FIG. 5D is a table in which a person ID, an eye image of the registered user which is used in the second authentication unit 505, a feature vector which is used in the second authentication unit 505, and the position of an index corresponding to the feature vector are associated with each other. In the various tables 520 to 540 illustrated in FIG. 5B to FIG. 5D, pieces of information about the same registered user are associated with each other by the person ID thereof. Here, extraction of the feature vector is performed with the use of, for example, a neural network, and the extracted feature vector is used for personal authentication of the user. Furthermore, the method for personal authentication of the user using an eye image is not limited to the above-mentioned method using a neural network, but can be a known method such as, for example, iris recognition.

Moreover, FIG. 5E is a diagram illustrating an example of an authentication state table 550 that the authentication state management unit 506 illustrated in FIG. 5A manages in the first embodiment. Even in the authentication state table 550 illustrated in FIG. 5E, as with the various tables 520 to 540 illustrated in FIG. 5B to FIG. 5D, pieces of information about the same registered user are associated with each other by the person ID thereof.

Here, the description refers back to FIG. 5A again.

The first authentication unit 504 is configured to perform authentication of an authentication target user based on an eye image (an authentication image) of the authentication target user obtained by the eye image sensor 219 and acquired by the eye image acquisition unit 501 before image capturing of a subject image by the image sensor 211. In the first embodiment, at a time when image capturing of a subject image by the image sensor 211 is not being performed, the first authentication unit 504 performs processing for authenticating whether the authentication target user is a person who is currently registered with the registration data management unit 503 (a registered user).

The second authentication unit 505 is configured to perform authentication of an authentication target user based on an eye image (an authentication image) of the authentication target user obtained by the eye image sensor 219 and acquired by the eye image acquisition unit 501 at a time when image capturing of a subject image by the image sensor 211 is being performed. In the first embodiment, at the time when image capturing of a subject image by the image sensor 211 is being performed, the second authentication unit 505 performs processing for authenticating whether a person authenticated by the first authentication unit 504 (an authentication target user) is performing image capturing of the subject image. Moreover, the second authentication unit 505 performs control in such a way as to continue an authentication state of the second authentication only during the process of image capturing of a subject image.

In the first embodiment, it is desirable that the first authentication unit 504 use authentication settings with a false acceptance rate set lower. On the other hand, it is desirable that the second authentication unit 505 use authentication settings with a false rejection rate set lower. As a method for implementing such authentication settings, for example, there is a method of, when the authentication methods that the first authentication unit 504 and the second authentication unit 505 use are the same, changing a threshold value for a degree of similarity. In this case, specifically, the first authentication unit 504 sets a high threshold value for the degree of similarity and the second authentication unit 505 sets a low threshold value for the degree of similarity. This enables making the false acceptance rate lower in the first authentication unit 504 and making the false rejection rate lower in the second authentication unit 505. Therefore, when it is difficult to make both the false acceptance rate and the false rejection rate lower only during image capturing, performing two-factor authentication enables making both the false acceptance rate and the false rejection rate lower.

The authentication state management unit 506 is configured to manage an authentication state of the first authentication, which is performed by the first authentication unit 504, and an authentication state of the second authentication, which is performed by the second authentication unit 505. Additionally, the authentication state management unit 506 also manages the presence or absence of usage by others. For example, the authentication state management unit 506 retains the authentication state table 550 illustrated in FIG. 5E in the memory unit 213 and performs management on the authentication state table 550.

The authentication state table 550 illustrated in FIG. 5E is described.

“First authentication state,” shown in the authentication state table 550, represents the current state of the first authentication performed by the first authentication unit 504 and takes a value which is any one of “unauthenticated,” “authentication failed,” or “authentication successful.” Moreover, “person ID” represents an ID of the person identified by the first authentication. When the first authentication state is “unauthenticated,” “person ID” becomes a value indicating a blank such as a null. “Second authentication state,” shown in the authentication state table 550, represents the current state of the second authentication performed by the second authentication unit 505 and takes a value which is any one of “unauthenticated,” “authentication failed,” or “authentication successful.” “Number of failures of first authentication,” shown in the authentication state table 550, represents the number of failures of the first authentication performed by the first authentication unit 504 and takes an integer value greater than or equal to 0. “Number of failures of second authentication,” shown in the authentication state table 550, represents the number of failures of the second authentication performed by the second authentication unit 505 and takes an integer value greater than or equal to 0. Furthermore, the authentication state table 550 illustrated in FIG. 5E is retained by being stored in the memory unit 213. The method of retaining the authentication state table 550 is not limited to a table structure, but can be, for example, a key-value structure.

The eyeball state acquisition unit 507 is configured to acquire the state of the eye (eyeball) E of the user from an eye image acquired by the eye image acquisition unit 501 or an eye image stored in the registration data management unit 503. Here, the state of the eyeball of the user refers to, for example, line-of-sight information about the user. Detection of the line of sight of the user uses, for example, the method described in Japanese Patent Laid-Open No. 2024-2562 to obtain the coordinates of corneal reflection images of the light sources 216a and 216b and the center of the pupil, which are observed on the eye image, and obtain, from the obtained coordinates, the gaze coordinates on the display device 214 of the user. For example, acquiring the line of sight of the user who is looking in the viewfinder (eyepiece lens 122) enables presenting, to the user via a user interface (UI) display, that by moving the line-of-sight from the current line-of-sight position it is possible to obtain a registered image and an authentication image that are suitable for authentication. Moreover, the above-mentioned line-of-sight information that is acquired as the state of the eye (eyeball) E of the user in the eyeball state acquisition unit 507 includes a line-of-sight direction of the user, and, in this case, the eyeball state acquisition unit 507 is configured to include a line-of-sight sensor that acquires line-of-sight information about the user. Furthermore, the state of the eye (eyeball) E of the user that is acquired by the eyeball state acquisition unit 507 is not limited to the above-mentioned line-of-sight information about the user. For example, the state of the eye (eyeball) E of the user that is acquired by the eyeball state acquisition unit 507 includes eye access information about the user, and, in this case, the eyeball state acquisition unit 507 is configured to include an eyepiece sensor 221 which acquires eye access information about the user. Moreover, for example, the state of the eye (eyeball) E of the user that is acquired by the eyeball state acquisition unit 507 includes eye image information obtained by performing image processing on an eye image acquired by the eye image acquisition unit 501 or an eye image stored in the registration data management unit 503. In this case, the eye image information can include, for example, information about, for example, the degree of opening of the eyelid or pupil of the user, the eye access position or eye access angle of the user, or the presence or absence of wearing eyewear.

The first presentation information determination unit 508 is a first determination unit configured to determine first presentation information including guidance information for guiding at least one of a position or direction of the eye (eyeball) E of the user when the eye image sensor 219 performs capturing of an eye image in a case where the first authentication unit 504 performs first authentication of the user. In this case, for example, the first presentation information determination unit 508 can determine the first presentation information based on the current state of the eye (eyeball) E of the user acquired by the eyeball state acquisition unit 507. Moreover, for example, the first presentation information determination unit 508 determines, as the first presentation information, UI information in such a way as to enable the eye image acquisition unit 501 to acquire an eye image suitable for the first authentication in the first authentication unit 504. In the first embodiment, the first presentation information determination unit 508 determines the first presentation information by selecting appropriate presentation information from among pieces of presentation information including a plurality of UI displays or a plurality of audio guides stored in the memory unit 213. In this case, the first presentation information determination unit 508 can perform the above-mentioned selection from among pieces of presentation information stored in the memory unit 213, based on the authentication state of the first authentication that the authentication state management unit 506 manages or the eye image acquired by the eye image acquisition unit 501 at the time of the first authentication. Additionally, the first presentation information determination unit 508 can perform the above-mentioned selection from among pieces of presentation information stored in the memory unit 213, based on the state of the eye (eyeball) E of the user acquired by the eyeball state acquisition unit 507 at the time of the first authentication or the registered eye image currently registered with the registration data management unit 503.

The second presentation information determination unit 509 is a second determination unit configured to determine second presentation information related to authentication processing by the second authentication unit 505 when the eye image sensor 219 performs capturing of an eye image in a case where the second authentication unit 505 performs authentication of the user. In this case, for example, the second presentation information determination unit 509 can determine the second presentation information based on the current state of the eye (eyeball) E of the user acquired by the eyeball state acquisition unit 507. Moreover, for example, the second presentation information determination unit 509 determines, as the second presentation information, UI information in such a way as to enable the eye image acquisition unit 501 to acquire an eye image suitable for the second authentication in the second authentication unit 505. In the first embodiment, the second presentation information determination unit 509 determines the second presentation information by selecting appropriate presentation information from among pieces of presentation information including a plurality of UI displays or a plurality of audio guides stored in the memory unit 213. In this case, the second presentation information determination unit 509 can perform the above-mentioned selection from among pieces of presentation information stored in the memory unit 213, based on the authentication state of the second authentication that the authentication state management unit 506 manages or the eye image acquired by the eye image acquisition unit 501 at the time of the second authentication. Additionally, the second presentation information determination unit 509 can perform the above-mentioned selection from among pieces of presentation information stored in the memory unit 213, based on the state of the eye (eyeball) E of the user acquired by the eyeball state acquisition unit 507 at the time of the second authentication or the registered eye image currently registered with the registration data management unit 503.

The information presentation unit 510 is configured to present, to the user, the first presentation information determined by the first presentation information determination unit 508 when the eye image sensor 219 performs capturing of an eye image in a case where the first authentication unit 504 performs authentication of the user. Moreover, the information presentation unit 510 is configured to present, to the user, the second presentation information determined by the second presentation information determination unit 509 when the eye image sensor 219 performs capturing of an eye image in a case where the second authentication unit 505 performs authentication of the user. For example, the information presentation unit 510, which performs processing for presenting the first presentation information and the second presentation information, is configured with at least one unit of a display unit, which is the display device 214 or the operation member 123 such as a touch panel, and a sound output unit, which is the loudspeaker 220. Then, the information presentation unit 510 performs UI display of the first presentation information or the second presentation information on the display unit or performs sound outputting of the first presentation information or the second presentation information as audio guides from the sound output unit.

### Registration Processing

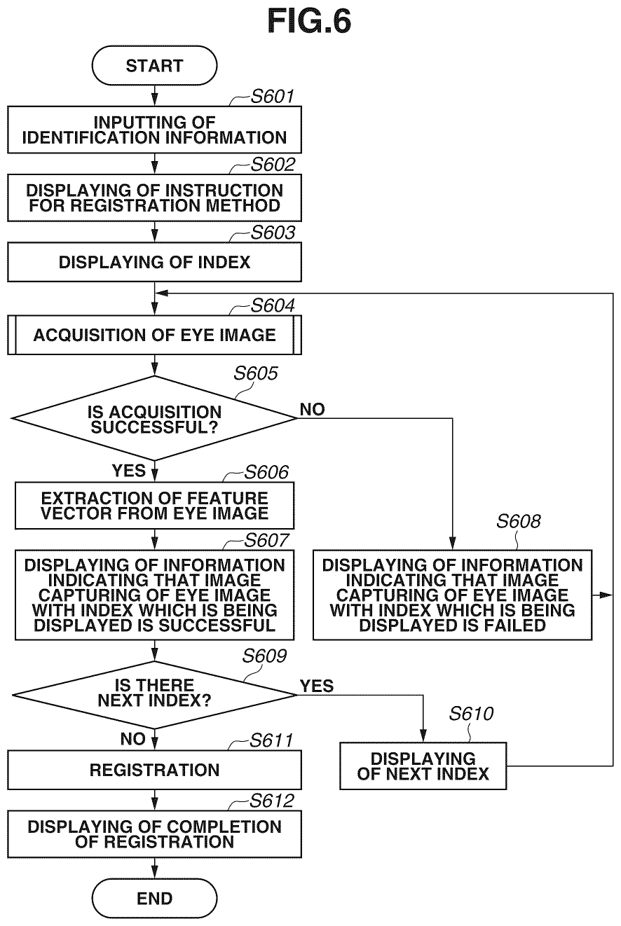

FIG. 6 is a flowchart illustrating an example of a detailed registration processing procedure in a control method for the image capturing apparatus 100 according to the first embodiment. The processing illustrated in the flowchart of FIG. 6 is implemented in the CPU 212 mainly by the registration unit 502. Moreover, the processing illustrated in the flowchart of FIG. 6 is assumed to be performed by the user operating the image capturing apparatus 100 at a time other than the time of image capturing. Therefore, the processing illustrated in the flowchart of FIG. 6 is implemented when the user has operated the image capturing apparatus 100 and has invoked the present processing from, for example, a menu. For example, the present processing is implemented when, for example, a menu screen (not illustrated) has been displayed on the touch panel (operation member 123) of the image capturing apparatus 100, and the user has operated the operation members 123 to 125, for example, to select, in the menu screen, a menu for invoking the present processing.

First, in step S601 illustrated in FIG. 6, the registration unit 502 performs acceptance of inputting of identification information about a person to be registered (registered user). In the first embodiment, the registration unit 502 performs acceptance of inputting of a “full name.” Specifically, the registration unit 502 displays a screen for inputting the full name (not illustrated) on the touch panel (operation member 123) and accepts inputting of the full name obtained by the user performing operations on the operation members 123 to 125. Upon completing the inputting, the user issues a notification indicating the completion of inputting of the full name by pressing, for example, a completion button displayed on the screen.

Next, in step S602 illustrated in FIG. 6, the registration unit 502 performs displaying of a registration method of an eye image to the user. Specifically, the registration unit 502 displays an instruction on the touch panel (operation member 123) in such a way as to instruct the user to look in the viewfinder. Moreover, the registration unit 502 displays an instruction in such a way as to let the user view an index displayed inside the viewfinder. Additionally, the registration unit 502 can display an instruction for enabling the capturing of a desired eye image in such a way as to instruct the user not to blink or instruct the user to open the user's eyes wide.

Next, in processing operations in step S603 to step S610 illustrated in FIG. 6, the registration unit 502 sequentially displays indexes 411 to 415 illustrated in FIG. 4C on the display device 214. Then, the registration unit 502 causes the registration data management unit 503 to retain eye images of the user obtained when the user has viewed the displayed indexes, feature vectors obtained from the eye images, and the positions of the indexes. Such processing operations are described below in sequence.

In step S603 illustrated in FIG. 6, the registration unit 502 displays an index on the display device 214. Specifically, the registration unit 502 displays only the index 411 illustrated in FIG. 4C and does not display the other indexes. Alternatively, while displaying all of the indexes 411 to 415 illustrated in FIG. 4C, the registration unit 502 can display only the index 411 with a highlighted color added thereto. Furthermore, another display method can be employed as long as it displays in such a way that it is capable of conveying to the user that the user should view the index 411.

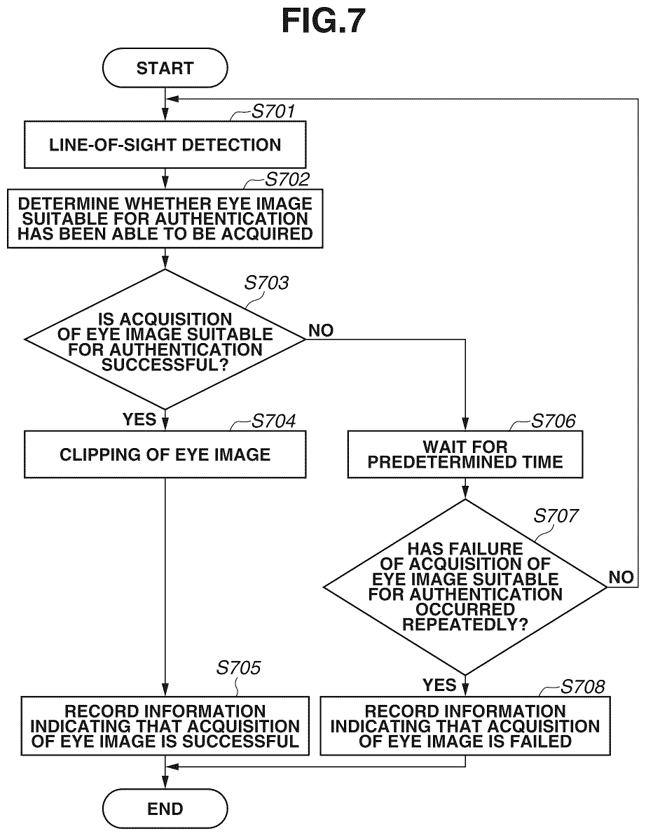

Next, in step S604 illustrated in FIG. 6, the eye image acquisition unit 501 acquires an eye image obtained when the user has looked in the viewfinder (eyepiece lens 122). Here, the details of a processing operation in step S604 illustrated in FIG. 6 are described with reference to FIG. 7.

FIG. 7 is a flowchart illustrating an example of a detailed processing procedure for acquisition of an eye image in step S604 illustrated in FIG. 6. The processing illustrated in the flowchart of FIG. 7 is implemented in the CPU 212 mainly by the eye image acquisition unit 501.

First, in step S701 illustrated in FIG. 7, the eye image acquisition unit 501 performs line-of-sight detection processing for the user. The line-of-sight detection processing for the user mentioned here can include processing for, with use of the method described in, for example, Japanese Patent Laid-Open No. 2024-2562, obtaining the coordinates of a corneal reflection image caused by the light sources 216a and 216b and the center of the pupil, which are observed on the eye image, and obtaining, from the obtained coordinates, the gaze coordinates of the user on the display device 214.

Next, in step S702 illustrated in FIG. 7, the eye image acquisition unit 501 determines whether an eye image suitable for authentication has been able to be acquired. Specifically, based on whether the line-of-sight detection processing performed in step S701 is successful, the eye image acquisition unit 501 determines whether an eye image suitable for authentication has been able to be acquired. For example, in the line-of-sight detection processing in step S701, the eye image acquisition unit 501 acquires an eye image (an eye image signal; an electrical signal of the eye image) from the eye image sensor 219 via the line-of-sight detection circuit 301. Next, the eye image acquisition unit 501 obtains the coordinates of a corneal reflection image caused by the light sources 216a and 216b and the center of the pupil, which are observed on the eye image. Next, the eye image acquisition unit 501 obtains, from the obtained coordinates, the gaze coordinates of the user on the display device 214. Then, if having not been able to detect, for example, the coordinates of the center of the pupil, the eye image acquisition unit 501 determines that processing for line-of-sight detection has failed. Therefore, in a case where, in processing for obtaining the coordinates of, for example, the center of the pupil, the eye image acquisition unit 501 has not been able to obtain such coordinates, the eye image acquisition unit 501 can determine that an eye image suitable for authentication has not been able to be acquired.

Next, in step S703 illustrated in FIG. 7, the eye image acquisition unit 501 branches the flow based on the determination of whether the acquisition of an eye image suitable for authentication is successful, which is based on a result of the determination in step S702.

If, in step S703 illustrated in FIG. 7, it is determined that the acquisition of an eye image suitable for authentication is successful (YES in step S703), the eye image acquisition unit 501 advances the processing to step S704.

In step S704 illustrated in FIG. 7, the eye image acquisition unit 501 generates an eye image by performing clipping. Specifically, first, the eye image acquisition unit 501 obtains the eye image acquired in step S701 illustrated in FIG. 7. Then, the eye image acquisition unit 501 uses the coordinates of the pupil center image c′ obtained in step S701 illustrated in FIG. 7 and performs cropping with a fixed size in such a manner that the pupil center image c′ becomes the image center. Additionally, the eye image acquisition unit 501 generates an eye image resized to an input size for a neural network which is used for extracting feature vectors.

Next, in step S705 illustrated in FIG. 7, the eye image acquisition unit 501 performs, with use of, for example, a flag, recording of information indicating that the acquisition of an eye image suitable for authentication is successful.

Moreover, if, in step S703 illustrated in FIG. 7, it is determined that the acquisition of an eye image suitable for authentication is not successful (has failed) (NO in step S703), the eye image acquisition unit 501 advances the processing to step S706.

In step S706 illustrated in FIG. 7, the eye image acquisition unit 501 performs processing for waiting for a predetermined amount of time, such as several hundred milliseconds. The processing in step S706 is processing for waiting in the hope that an eye image changes and line-of-sight detection becomes successful.

Next, in step S707 illustrated in FIG. 7, the eye image acquisition unit 501 determines whether the failure of acquisition of an eye image suitable for authentication has occurred repeatedly by a predetermined number of times. The failure mentioned here refers to the case where, in step S703 illustrated in FIG. 7, it is determined that an eye image suitable for authentication has not been able to be acquired (NO in step S703).

If, in step S707 illustrated in FIG. 7, it is determined that the failure of acquisition of an eye image suitable for authentication has not occurred repeatedly by the predetermined number of times (NO in step S707), the eye image acquisition unit 501 returns the processing to step S701 and then performs processing operations in step S701 and subsequent steps again.

Moreover, if, in step S707 illustrated in FIG. 7, it is determined that the failure of acquisition of an eye image suitable for authentication has occurred repeatedly by the predetermined number of times (YES in step S707), the eye image acquisition unit 501 advances the processing to step S708.

Next, in step S708 illustrated in FIG. 7, the eye image acquisition unit 501 performs, with use of, for example, a flag, recording of information indicating that the acquisition of an eye image suitable for authentication has failed. In this case, the eye image acquisition unit 501 can further perform recording of the eye image which has previously been acquired in step S702 illustrated in FIG. 7.

In a case where the processing operation in step S705 illustrated in FIG. 7 has ended or in a case where the processing operation in step S708 illustrated in FIG. 7 has ended, the processing illustrated in the flowchart of FIG. 7 ends. Then, when the processing illustrated in the flowchart of FIG. 7 has ended, the acquisition processing for an eye image in step S604 illustrated in FIG. 6 ends.

Here, the description refers back to FIG. 6 again.

After the acquisition processing in step S604 illustrated in FIG. 6 has ended, the eye image acquisition unit 501 advances the processing to step S605.

In step S605 illustrated in FIG. 6, the eye image acquisition unit 501 determines whether the acquisition of an eye image is successful. Specifically, the eye image acquisition unit 501 uses the flag recorded in step S705 or step S708 illustrated in FIG. 7 to determine whether the acquisition of an eye image is successful.

If, in step S605 illustrated in FIG. 6, it is determined that the acquisition of an eye image is successful (YES in step S605), the eye image acquisition unit 501 advances the processing to step S606.

In step S606 illustrated in FIG. 6, the eye image acquisition unit 501 or the registration unit 502 performs extraction of a feature vector from the eye image acquired in step S604 illustrated in FIG. 6 as authentication registration information for authenticating the user. Here, for example, a neural network is used for the extraction of a feature vector and the extracted feature vector is used for personal authentication of the user. Furthermore, the method of personal authentication of the user using an eye image is not limited to the above-mentioned method using a neural network, but can be, for example, a known method such as iris recognition.

Next, in step S607 illustrated in FIG. 6, the registration unit 502 displays, on the display device 214, information indicating that image capturing of an eye image with an index that is being displayed on the display device 214 is successful. For example, on the display device 214, the registration unit 502 can display a message such as “Image capturing of an eye image is successful,” or can display, for example, an icon indicating such a success.

Moreover, if, in step S605 illustrated in FIG. 6, it is determined that the acquisition of an eye image is not successful (has failed) (NO in step S605), the eye image acquisition unit 501 advances the processing to step S608.

In step S608 illustrated in FIG. 6, the registration unit 502 displays, on the display device 214, information indicating that image capturing of an eye image with an index that is being displayed on the display device 214 has failed. For example, on the display device 214, the registration unit 502 can display a message such as “Image capturing of an eye image has failed,” or can display, for example, an icon indicating such a failure. After the processing operation in step S608 has ended, the registration unit 502 returns the processing to step S604.

Moreover, after the processing operation in step S607 illustrated in FIG. 6 has ended, the registration unit 502 advances the processing to step S609.

In step S609 illustrated in FIG. 6, the registration unit 502 determines whether there is any index that has not yet been displayed. The registration unit 502 checks whether all of the indexes 411 to 415 illustrated in FIG. 4C have already been displayed to determine whether there is any index that has not yet been displayed.

If, in step S609 illustrated in FIG. 6, it is determined that there is an index that has not yet been displayed (YES in step S609), the registration unit 502 advances the processing to step S610.

In step S610 illustrated in FIG. 6, the registration unit 502 displays, on the display device 214, a next index from among the indexes that have not yet been displayed. For example, when the registration unit 502 has displayed the index 411 illustrated in FIG. 4C, the registration unit 502 displays the index 412 as a next index on the display device 214. In this way, the registration unit 502 selects the indexes 411 to 415 in the order of index numbers and displays the selected index on the display device 214. After the processing operation in step S610 has ended, the registration unit 502 returns the processing to step S604.

Moreover, if, in step S609 illustrated in FIG. 6, it is determined that there is no index that has not yet been displayed (NO in step S609), the registration unit 502 advances the processing to step S611.

In step S611 illustrated in FIG. 6, the registration unit 502 stores and registers the obtained pieces of information in the registered identification information table 520, the first authentication registration data table 530, and the second authentication registration data table 540 of the registration data management unit 503. Specifically, because person IDs in the three tables 520 to 540 illustrated in FIG. 5B to FIG. 5D are IDs for indicating a relationship between such tables, the registration unit 502 uses the same ID values in the three tables 520 to 540. Specifically, the registration unit 502 additively registers the full name included in the identification information obtained in step S601 illustrated in FIG. 6 with the registered identification information table 520 illustrated in FIG. 5B. Moreover, the registration unit 502 divisionally registers the feature vector obtained in step S606 illustrated in FIG. 6, an eye image corresponding to the feature vector, and the position of an index with the first authentication registration data table 530 illustrated in FIG. 5C and the second authentication registration data table 540 illustrated in FIG. 5D. The method of such divisional registration is as follows.

In first authentication processing in the first authentication registration data table 530 illustrated in FIG. 5C, the registration unit 502 displays an index on the display device 214 and the first authentication unit 504 performs authentication with use of an eye image obtained when the user has viewed the index.

Therefore, the registration unit 502 registers only the extracted feature vector of the index that has been displayed at that time, as a feature vector for first authentication registration, with the first authentication registration data table 530 illustrated in FIG. 5C. In the first embodiment, with the first authentication registration data table 530 illustrated in FIG. 5C, the registration unit 502 registers a feature vector 1 obtained when the index 411 illustrated in FIG. 4C has been displayed.

Moreover, in second authentication processing in the second authentication registration data table 540 illustrated in FIG. 5D, because a subject image that is being captured in the image sensor 211 is displayed on the display device 214, the registration unit 502 does not perform displaying of any index. Therefore, it is uncertain at which portion of the display device 214 the user gazes. Accordingly, in the first embodiment, with the second authentication registration data table 540 illustrated in FIG. 5D, the registration unit 502 registers all of the feature vectors 1 to 5 obtained when the indexes 411 to 415 illustrated in FIG. 4C have been displayed, respectively.

Next, in step S612 illustrated in FIG. 6, the registration unit 502 displays a message informing the user of the completion of registration on the touch panel (operation member 123) or the display device 214.

After the processing operation in step S612 illustrated in FIG. 6 has ended, the processing illustrated in the flowchart of FIG. 6 ends. Furthermore, in the processing illustrated in the flowchart of FIG. 6, because, unless, in step S605, it is determined that the acquisition of an eye image is successful, an infinite loop, in which the processing does not end, occurs, it is desirable to employ a configuration in which, for example, in a case where a predetermined number of failures have been observed, the registration unit 502 interrupts the processing. Moreover, the first embodiment is not limited to this configuration, and it is desirable that processing for coping with an abnormal case be added as appropriate.

### First Authentication Processing

Next, the first authentication processing that is performed by the first authentication unit 504 is described.

In the first embodiment, the first authentication is what is called active authentication, in which the user cooperates to acquire an eye image, and which therefore has a high likelihood of being able to obtain a high-quality eye image at the time of registration with the cooperation of the user.

Therefore, acquiring a high-quality eye image even at the time of the first authentication enables increasing the accuracy of the first authentication.

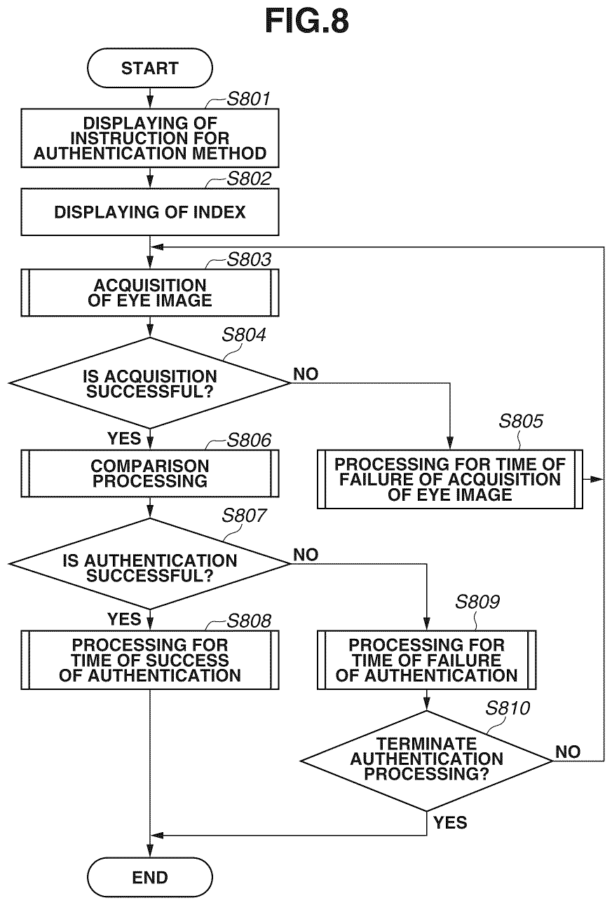

FIG. 8 is a flowchart illustrating an example of a detailed first authentication processing procedure in the control method for the image capturing apparatus 100 according to the first embodiment. The processing illustrated in the flowchart of FIG. 8 is performed in the CPU 212 mainly by the first authentication unit 504. The processing illustrated in the flowchart of FIG. 8 is assumed to be performed by the user operating the image capturing apparatus 100 at a time other than the time of image capturing.

Therefore, the processing illustrated in the flowchart of FIG. 8 is implemented when the user has operated the image capturing apparatus 100 and has invoked the present processing from, for example, a menu. For example, the present processing is implemented when, for example, a menu screen (not illustrated) has been displayed on the touch panel (operation member 123) of the image capturing apparatus 100 and the user has operated the operation members 123 to 125, for example, to select, in the menu screen, a menu for invoking the present processing.

First, in step S801 illustrated in FIG. 8, the first authentication unit 504 displays a predetermined screen on the touch panel (operation member 123) via the first presentation information determination unit 508 and the information presentation unit 510 and thus issues an instruction for the authentication method to the user. Specifically, the first authentication unit 504 displays an instruction on the touch panel (operation member 123) in such a way as to let the user look in the viewfinder and view an index displayed on the display device 214, via the first presentation information determination unit 508 and the information presentation unit 510. Additionally, the first authentication unit 504 can display an instruction for enabling the capturing of a desired eye image in such a way as to instruct the user not to blink, instruct the user to open the user's eyes wide, or instruct the user to tightly hold the image capturing apparatus 100, via the first presentation information determination unit 508 and the information presentation unit 510.

Next, in step S802 illustrated in FIG. 8, the first authentication unit 504 displays an index on the display device 214 via the first presentation information determination unit 508 and the information presentation unit 510. Specifically, as illustrated in FIG. 4D, the first authentication unit 504 displays only the index 411. This is because, at the time of the above-mentioned registration processing, a feature vector obtained when the user has viewed the index 411 has already been registered as a registered feature vector for the first authentication processing with the first authentication registration data table 530 illustrated in FIG. 5C. In this way, because eye images that are based on similar lines of sight can be obtained at the time of registration and at the time of authentication, it is possible to reduce a change in appearance between a registered image and an authentication image and, thus, it becomes easy to perform a comparison between the registered image and the authentication image.

Next, in step S803 illustrated in FIG. 8, the first authentication unit 504 performs, via the eye image acquisition unit 501, acquisition of an eye image obtained when the user has looked in the viewfinder (eyepiece lens 122). Specifically, the eye image acquisition unit 501 performs acquisition of an eye image by performing the processing illustrated in FIG. 7.

Next, in step S804 illustrated in FIG. 8, the first authentication unit 504 determines whether the acquisition of an eye image is successful in step S803. Specifically, the first authentication unit 504 determines the success or failure of the acquisition of an eye image based on the applicable flags recorded in step S705 and step S708 illustrated in FIG. 7.

If, in step S804 illustrated in FIG. 8, it is determined that the acquisition of an eye image is not successful (has failed) in step S803 (NO in step S804), the first authentication unit 504 advances the processing to step S805.

In step S805 illustrated in FIG. 8, the first authentication unit 504 performs processing for the time of failure of the acquisition of an eye image.

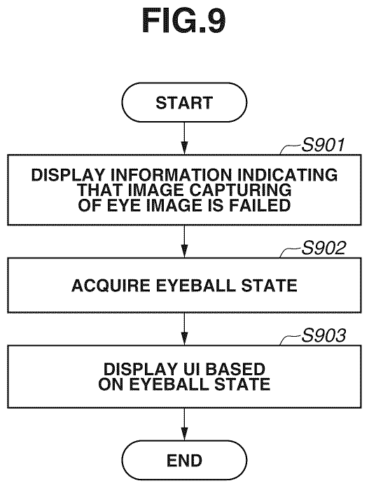

FIG. 9 is a flowchart illustrating an example of a detailed processing procedure for the time of failure of the acquisition of an eye image in step S805 illustrated in FIG. 8.

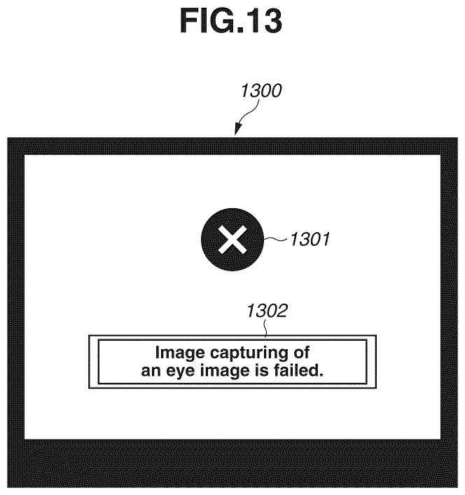

First, in step S901 illustrated in FIG. 9, the first authentication unit 504 displays information indicating that image capturing of an eye image at the time of the first authentication has failed on the display device 214 via the first presentation information determination unit 508 and the information presentation unit 510. FIG. 13 is a diagram illustrating an example of a display screen 1300 that is displayed in the display processing in step S901 illustrated in FIG. 9. As shown in the display screen 1300 illustrated in FIG. 13, in the display processing in step S901 illustrated in FIG. 9, the first authentication unit 504 can display a message 1302, “Image capturing of an eye image is failed,” or can display an icon 1301 that indicates the failure of image capturing of an eye image.

Next, in step S902 illustrated in FIG. 9, the eyeball state acquisition unit 507 acquires the state of the eye (eyeball) E of the user from the eye image acquired in step S803 illustrated in FIG. 8. Here, it is assumed that the eyeball state acquisition unit 507 acquires line-of-sight information about the user as the state of the eye (eyeball) E of the user.

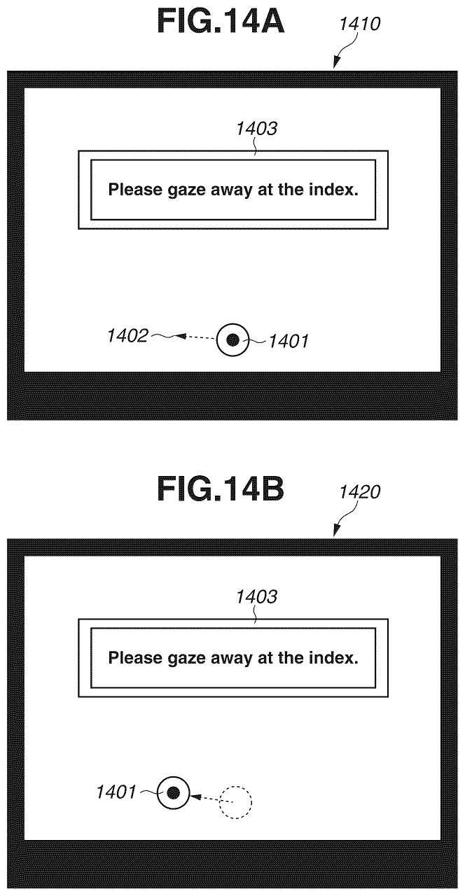

Next, in step S903 illustrated in FIG. 9, the information presentation unit 510 displays, via the first presentation information determination unit 508, a user interface (UI) based on the first authentication registration data table 530 illustrated in FIG. 5C and the state of the eye (eyeball) E of the user acquired in step S902. In the displaying of a UI in step S903, first presentation information including guidance information for guiding at least one of a position or a direction of the eye (eyeball) E of the user is displayed. Specifically, in a case where the eyeball state acquisition unit 507 acquires line-of-sight information about the user as the state of the eye (eyeball) E of the user, the first presentation information determination unit 508 determines, based on the current position of the line of sight, a UI for guiding the line of sight to the position of the index shown in the first authentication registration data table 530 illustrated in FIG. 5C. Then, the information presentation unit 510 displays the UI determined by the first presentation information determination unit 508 in the entire screen of the touch panel (operation member 123) or the display device 214. FIGS. 14A and 14B are diagrams illustrating examples of display screens 1410 and 1420 each of which is displayed in the display processing in step S903 illustrated in FIG. 9. In the display processing in step S903 illustrated in FIG. 9, the information presentation unit 510 displays a marker 1401 at the current position of the line of sight as shown in the display screen 1410 illustrated in FIG. 14A. Next, in the display processing in step S903 illustrated in FIG. 9, the information presentation unit 510 moves the marker 1401 to the position 1402 corresponding to the index in the first authentication registration data table 530, as shown in the display screens 1410 and 1420 illustrated in FIG. 14A and FIG. 14B. Additionally, the information presentation unit 510 can also display a message 1403, serving as one piece of guidance information for guiding the user in such a way as to prompt the user to gaze at the index, as illustrated in FIG. 14A and FIG. 14B. Guiding the line of sight of the user along with the movement of the position of the marker 1401 illustrated in FIG. 14A and FIG. 14B enables bringing the line of sight of the user closer to the position of the index in the first authentication registration data table 530 and thus enables increasing the quality of an authentication image.

When the processing operation in step S903 illustrated in FIG. 9 has ended, the processing illustrated in the flowchart of FIG. 9 ends. Then, when the processing illustrated in the flowchart of FIG. 9 has ended, the processing for the time of failure of the acquisition of an eye image in step S805 illustrated in FIG. 8 ends. When the processing operation in step S805 illustrated in FIG. 8 has ended, the first authentication unit 504 returns the processing to step S803.

Here, the description refers back to FIG. 8 again.

If, in step S804 illustrated in FIG. 8, it is determined that the acquisition of an eye image in step S803 is successful (YES in step S804), the first authentication unit 504 advances the processing to step S806.

In step S806 illustrated in FIG. 8, the first authentication unit 504 performs comparison processing between a registered image, which is a previously registered eye image, and an authentication image, which is the eye image acquired in step S803.

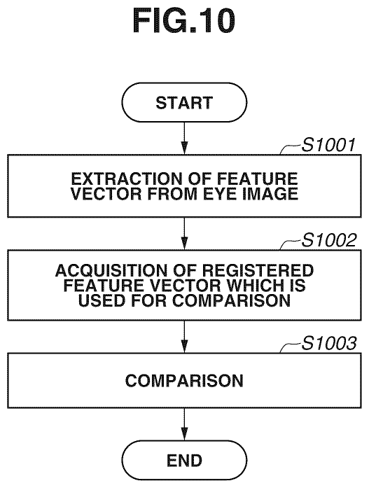

FIG. 10 is a flowchart illustrating an example of a detailed comparison processing procedure in step S806 illustrated in FIG. 8.

First, in step S1001 illustrated in FIG. 10, the first authentication unit 504 performs extraction of a feature vector from the eye image acquired in step S803. Here, for example, a neural network is used for the extraction of a feature vector, and the extracted feature vector is used for personal authentication of the user. Furthermore, the method of personal authentication of the user using an eye image is not limited to the above-mentioned method using a neural network, and, for example, a known method such as, for example, iris recognition can be used.

Next, in step S1002 illustrated in FIG. 10, the first authentication unit 504 acquires, from the registration data management unit 503, a registered feature vector which is used for the first authentication. Specifically, the first authentication unit 504 acquires all of the feature vectors shown in the first authentication registration data table 530 illustrated FIG. 5C.

Next, in step S1003 illustrated in FIG. 10, the first authentication unit 504 performs comparison between the feature vector targeted for authentication extracted in step S1001 and the registered feature vector acquired in step S1002. Specifically, the first authentication unit 504 obtains a cosine similarity of the two feature vectors and determines whether the obtained cosine similarity exceeds a preliminarily determined threshold value. Then, the first authentication unit 504 identifies a person ID with a registered feature vector the cosine similarity of which has exceeded the threshold value.

When the processing operation in step S1003 illustrated in FIG. 10 has ended, the processing illustrated in the flowchart of FIG. 10 ends. Then, when the processing illustrated in the flowchart of FIG. 10 has ended, the comparison processing in step S806 illustrated in FIG. 8 ends.

Here, the description refers back to FIG. 8 again.

Next, in step S807 illustrated in FIG. 8, the first authentication unit 504 determines whether the first authentication is successful. Specifically, in a case where there is a registered feature vector the cosine similarity of which has exceeded the threshold value in step S806 illustrated in FIG. 8 (specifically, in step S1003 illustrated in FIG. 10), the first authentication unit 504 determines that the first authentication is successful.

If, in step S807 illustrated in FIG. 8, it is determined that the first authentication is successful (YES in step S807), the first authentication unit 504 advances the processing to step S808.

In step S808 illustrated in FIG. 8, the first authentication unit 504 performs processing for the time of success of authentication.

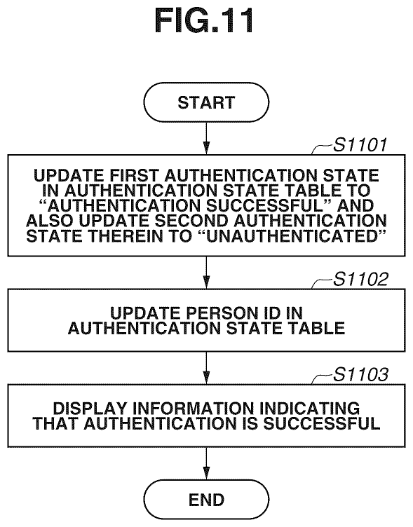

FIG. 11 is a flowchart illustrating an example of a detailed processing procedure for the time of success of authentication in step S808 illustrated in FIG. 8.

In step S1101 illustrated in FIG. 11, the first authentication unit 504 causes the authentication state management unit 506 to update the first authentication state in the authentication state table 550 illustrated in FIG. 5E to “authentication successful” and also update the second authentication state therein to “unauthenticated.” Additionally, the first authentication unit 504 causes the authentication state management unit 506 to update the number of failures of first authentication shown in the authentication state table 550 illustrated in FIG. 5E to “0.”

Next, in step S1102 illustrated in FIG. 11, the first authentication unit 504 causes the authentication state management unit 506 to update the person ID in the authentication state table 550 illustrated in FIG. 5E to the person ID identified in step S806 illustrated in FIG. 8 (specifically, step S1003 illustrated in FIG. 10).

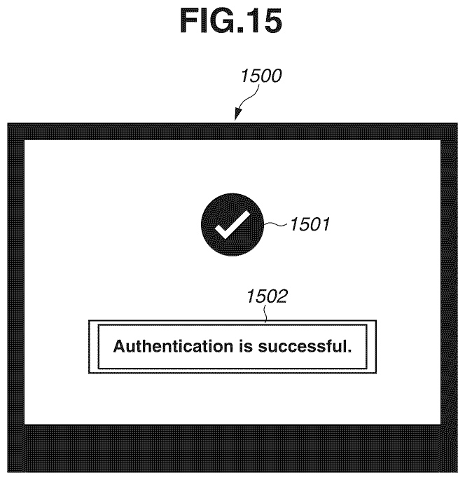

Next, in step S1103 illustrated in FIG. 11, the first authentication unit 504 displays information indicating that the first authentication is successful on the touch panel (operation member 123) or the display device 214 via the first presentation information determination unit 508 and the information presentation unit 510. FIG. 15 is a diagram illustrating an example of a display screen 1500 that is displayed in the display processing in step S1103 illustrated in FIG. 11. As shown in the display screen 1500 illustrated in FIG. 15, in the display processing in step S1103 illustrated in FIG. 11, the first authentication unit 504 can display a message 1502, “Authentication is successful,” or can display an icon 1501 which indicates the success of authentication.

When the processing operation in step S1103 illustrated in FIG. 11 has ended, the processing illustrated in the flowchart of FIG. 11 ends. Then, when the processing illustrated in the flowchart of FIG. 11 has ended, the processing for the time of success of authentication in step S808 illustrated in FIG. 8 ends.

Here, the description refers back to FIG. 8 again.

If, in step S807 illustrated in FIG. 8, it is determined that the first authentication is not successful (has failed) (NO in step S807), the first authentication unit 504 advances the processing to step S809.

In step S809 illustrated in FIG. 8, the first authentication unit 504 performs processing for the time of failure of authentication.

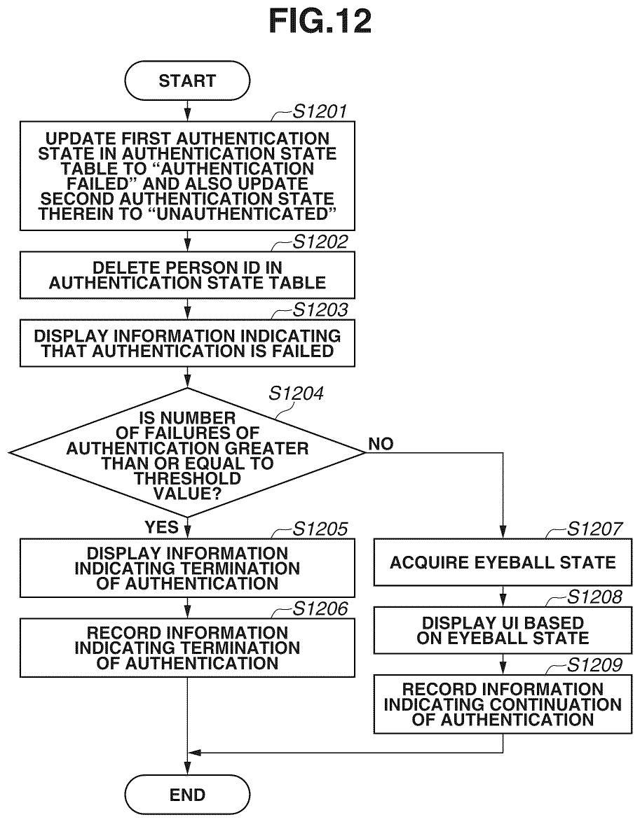

FIG. 12 is a flowchart illustrating an example of a detailed processing procedure for the time of failure of authentication in step S809 illustrated in FIG. 8.

In step S1201 illustrated in FIG. 12, the first authentication unit 504 causes the authentication state management unit 506 to update the first authentication state in the authentication state table 550 illustrated in FIG. 5E to “authentication failed” and also update the second authentication state therein to “unauthenticated.” Additionally, the first authentication unit 504 causes the authentication state management unit 506 to update the number of failures of first authentication shown in the authentication state table 550 illustrated in FIG. 5E by adding “1” to the number of failures of first authentication.

Next, in step S1202 illustrated in FIG. 12, the first authentication unit 504 causes the authentication state management unit 506 to delete the person ID in the authentication state table 550 illustrated in FIG. 5E. For example, a configuration in which a NULL value is preliminarily prepared as a value indicating an empty value and the authentication state management unit 506 overwrites the person ID with the NULL value can be employed.

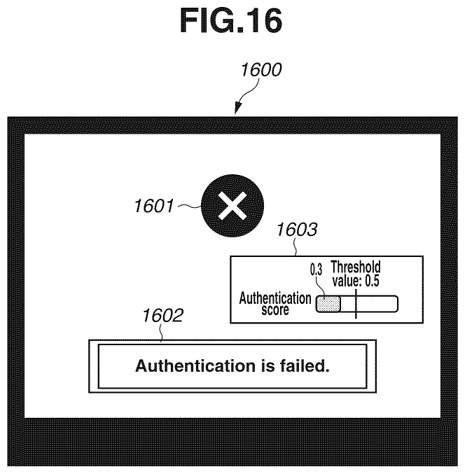

Next, in step S1203 illustrated in FIG. 12, the first authentication unit 504 displays information indicating that the first authentication has failed on the touch panel (operation member 123) or the display device 214 via the first presentation information determination unit 508 and the information presentation unit 510. FIG. 16 is a diagram illustrating an example of a display screen 1600 that is displayed in the display processing in step S1203 illustrated in FIG. 12. As shown in the display screen 1600 illustrated in FIG. 16, in the display processing in step S1203 illustrated in FIG. 12, the first authentication unit 504 can display a message 1602, “Authentication is failed,” or can display an icon 1601 that indicates the failure of authentication. Additionally, as shown in the display screen 1600 illustrated in FIG. 16, in the display processing in step S1203 illustrated in FIG. 12, the first authentication unit 504 can display an illustration 1603 indicating the cosine similarity obtained in step S806 illustrated in FIG. 8 (specifically, step S1003 illustrated in FIG. 10) and the threshold value. While, in the display screen 1600 illustrated in FIG. 16, the cosine similarity and the threshold value are directly displayed in the illustration 1603, a display method that the user can easily understand, such as the method of, for example, converting the cosine similarity and the threshold value into integer values by multiplying them by respective constants and displaying the integer values, only needs to be employed.

Next, in step S1204 illustrated in FIG. 12, the first authentication unit 504 determines, via the authentication state management unit 506, whether the number of failures (the number of consecutive failures) of first authentication in the authentication state table 550 illustrated in FIG. 5E is greater than or equal to a predetermined first threshold value. Here, the first threshold value is assumed to be a positive integer and a fixed value, but it can be an optional threshold value that the user is allowed to set.

If, in step S1204 illustrated in FIG. 12, it is determined that the number of failures (the number of consecutive failures) of first authentication in the authentication state table 550 illustrated in FIG. 5E is greater than or equal to the first threshold value (YES in step S1204), the first authentication unit 504 advances the processing to step S1205.

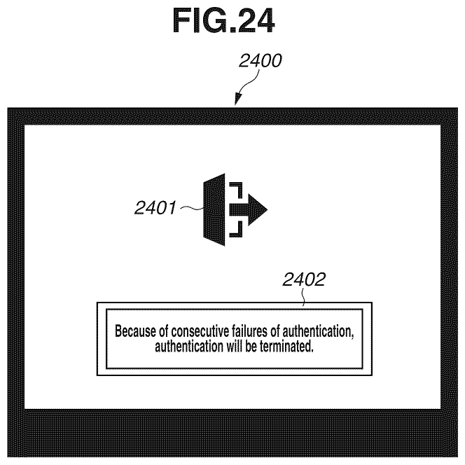

In step S1205 illustrated in FIG. 12, first, the first authentication unit 504 performs initialization by causing the authentication state management unit 506 to update the first authentication state in the authentication state table 550 illustrated in FIG. 5E to “unauthenticated” and also update the number of failures of first authentication to “0.” Next, in step S1205 illustrated in FIG. 12, the first authentication unit 504 displays information indicating that the first authentication unit 504 terminates the first authentication on the touch panel (operation member 123) or the display device 214 via the first presentation information determination unit 508 and the information presentation unit 510. FIG. 24 is a diagram illustrating an example of a display screen 2400 that is displayed in the display processing in step S1205 illustrated in FIG. 12. As shown in the display screen 2400 illustrated in FIG. 24, in the display processing in step S1205 illustrated in FIG. 12, the first authentication unit 504 can display a message 2402, “Because of consecutive failures of authentication, authentication will be terminated,” or can display an icon 2401 indicating the termination of authentication.

Next, in step S1206 illustrated in FIG. 12, the first authentication unit 504 records information indicating that the first authentication unit 504 terminates the first authentication with, for example, a flag.

Moreover, if, in step S1204 illustrated in FIG. 12, it is determined that the number of failures (the number of consecutive failures) of first authentication in the authentication state table 550 illustrated in FIG. 5E is less than the first threshold value (NO in step S1204), the first authentication unit 504 advances the processing to step S1207.

In step S1207 illustrated in FIG. 12, the eyeball state acquisition unit 507 acquires the state of the eye (eyeball) E of the user from the eye image acquired in step S803 illustrated in FIG. 8. Here, it is assumed that the eyeball state acquisition unit 507 acquires line-of-sight information about the user as the state of the eye (eyeball) E of the user.

Next, in step S1208 illustrated in FIG. 12, the information presentation unit 510 displays, via the first presentation information determination unit 508, a user interface (UI) based on the first authentication registration data table 530 illustrated in FIG. 5C and the state of the eye (eyeball) E of the user acquired in step S1207. Specifically, in a case where the eyeball state acquisition unit 507 acquires line-of-sight information about the user as the state of the eye (eyeball) E of the user, the first presentation information determination unit 508 determines, based on the current position of the line of sight, a UI for guiding the line of sight to the position of the index shown in the first authentication registration data table 530 illustrated in FIG. 5C. Then, the information presentation unit 510 displays the UI determined by the first presentation information determination unit 508 on the touch panel (operation member 123) or the display device 214. For example, as shown in the display screen 1410 illustrated in FIG. 14A, the information presentation unit 510 displays a marker 1401 at the current position of the line of sight. Next, as shown in the display screens 1410 and 1420 illustrated in FIG. 14A and FIG. 14B, the information presentation unit 510 moves the marker 1401 to the position 1402 corresponding to the index in the first authentication registration data table 530. Additionally, the information presentation unit 510 can also display a message 1403, serving as one piece of guidance information for guiding the user in such a way as to prompt the user to gaze at the index, as illustrated in FIG. 14A and FIG. 14B. Guiding the line of sight of the user along with the movement of the position of the marker 1401 illustrated in FIG. 14A and FIG. 14B enables bringing the line of sight of the user closer to the position of the index in the first authentication registration data table 530 and thus enables increasing the quality of an authentication image.

Next, in step S1209 illustrated in FIG. 12, the first authentication unit 504 records information indicating that the first authentication unit 504 continues the first authentication with, for example, a flag.

When the processing operation in step S1206 illustrated in FIG. 12 has ended or when the processing operation in step S1209 illustrated in FIG. 12 has ended, the processing illustrated in the flowchart of FIG. 12 ends. Then, when the processing illustrated in the flowchart of FIG. 12 has ended, the processing for the time of failure of authentication in step S809 illustrated in FIG. 8 ends.

Here, the description refers back to FIG. 8.

Next, in step S810 illustrated in FIG. 8, the first authentication unit 504 determines whether to terminate the first authentication processing. Specifically, based on the flag recorded in step S1206 or step S1209 illustrated in FIG. 12, the first authentication unit 504 determines whether to terminate the first authentication processing.

If, in step S810 illustrated in FIG. 8, it is determined not to terminate (it is determined to continue) the first authentication processing (NO in step S810), the first authentication unit 504 returns the processing to step S803 and then performs processing operations in step S803 and subsequent steps again.

Moreover, if, in step S810 illustrated in FIG. 8, it is determined to terminate the first authentication processing (YES in step S810) or if the processing operation in step S808 illustrated in FIG. 8 has ended, the first authentication unit 504 ends the processing illustrated in the flowchart of FIG. 8. Furthermore, in the processing illustrated in the flowchart of FIG. 8, because, unless, in step S804, it is determined that the acquisition of an eye image is successful, an infinite loop, in which the processing does not end, occurs, it is desirable to employ a configuration in which, for example, in a case where a predetermined number of failures have been observed, the first authentication unit 504 interrupts the processing. Moreover, the first embodiment is not limited to this configuration, and it is desirable that processing for coping with an abnormal case be added as appropriate.

### Second Authentication Processing

Next, the second authentication processing, which is performed by the second authentication unit 505, is described.

In the first embodiment, since the second authentication is an authentication that is performed concurrently with an image capturing operation for a subject image performed by the user, it is favorable that the second authentication is an authentication that, where possible, does not hinder the image capturing operation for a subject image performed by the user.

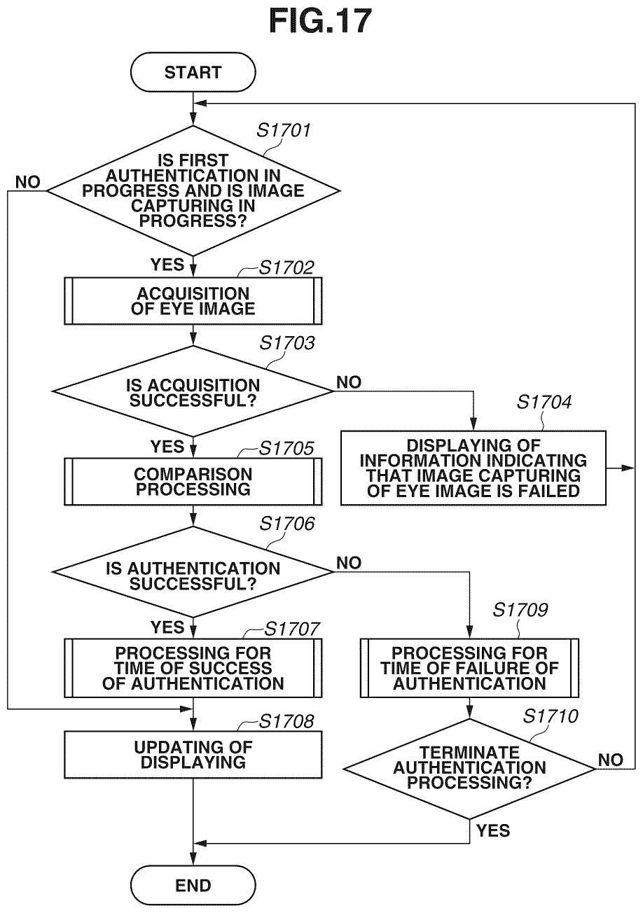

FIG. 17 is a flowchart illustrating an example of a detailed second authentication processing procedure in the control method for the image capturing apparatus 100 according to the first embodiment. The processing illustrated in the flowchart of FIG. 17 is performed in the CPU 212 mainly by the second authentication unit 505. The processing illustrated in the flowchart of FIG. 17 is assumed to be performed when the user has looked in the viewfinder (eyepiece lens 122) at the time of image capturing of a subject image. Therefore, the processing illustrated in the flowchart of FIG. 17 is started in response to the eyepiece sensor 221 detecting that the user has brought the eye (eyeball) E close to the viewfinder (eyepiece lens 122). Furthermore, the eyepiece sensor 221 can be, for example, a sensor that detects that the skin around the eye (eyeball) E of the user has come into contact with the periphery of the eyepiece lens 122 or a sensor that detects an eye access distance being a distance between the eyepiece lens 122 and the eye (eyeball) E of the user. For example, if the eye access distance becomes a distance less than or equal to a predetermined value, it is possible to determine that the user is looking in the viewfinder (eyepiece lens 122).

Moreover, as a start condition for the processing illustrated in the flowchart of FIG. 17, a configuration in which the processing illustrated in the flowchart of FIG. 17 is started in response to it being detected that the release button 121 has been pressed to the first stroke can be employed. Additionally, as a start condition for the processing illustrated in the flowchart of FIG. 17, a configuration in which the line-of-sight detection processing is preliminarily started and the processing illustrated in the flowchart of FIG. 17 is started when the line-of-sight detection processing is successful, can be employed.

First, in step S1701 illustrated in FIG. 17, the second authentication unit 505 determines whether the first authentication is in progress and the user is continuing image capturing of a subject image (image capturing is in progress). Here, the second authentication unit 505 determines whether the first authentication is in progress by determining, via the authentication state management unit 506, whether the first authentication state in the authentication state table 550 illustrated in FIG. 5E is “authentication successful.” Moreover, the second authentication unit 505 determines whether the user is continuing image capturing of a subject image (image capturing is in progress) by determining, via the eyepiece sensor 221, whether the user remains in the state of bringing the eye close to the viewfinder (eyepiece lens 122). Furthermore, the second authentication unit 505 can determine whether image capturing of a subject image is in progress by another method such as detecting pressing of the release button 121 or using line-of-sight detection processing.

If, in step S1701 illustrated in FIG. 17, it is determined that the first authentication is in progress and the user is continuing image capturing of a subject image (image capturing is in progress) (YES in step S1701), the second authentication unit 505 advances the processing to step S1702.

In step S1702 illustrated in FIG. 17, the eye image acquisition unit 501 performs acquisition of an eye image obtained when the user has looked in the viewfinder (eyepiece lens 122). A specific processing operation in step S1702 illustrated in FIG. 17 is the same as the processing operation in step S604 illustrated in FIG. 6 (the processing illustrated in the flowchart of FIG. 7) and is, therefore, omitted from description here. Furthermore, in a case where line-of-sight detection processing is already started, the second authentication unit 505 can skip the line-of-sight detection in step S701 illustrated in FIG. 7 and use a result of the already started line-of-sight detection processing.

Next, in step S1703 illustrated in FIG. 17, the eye image acquisition unit 501 determines whether the acquisition of an eye image is successful. Specifically, the eye image acquisition unit 501 determines the success or failure of the acquisition of an eye image based on the applicable flag recorded in step S705 or step S708 illustrated in FIG. 7.

If, in step S1703 illustrated in FIG. 17, it is determined that the acquisition of an eye image is not successful (has failed) (NO in step S1703), the eye image acquisition unit 501 advances the processing to step S1704.

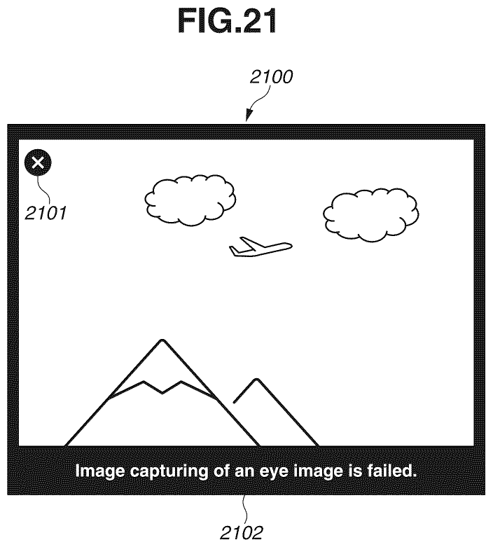

In step S1704 illustrated in FIG. 17, the second authentication unit 505 displays information indicating that image capturing of an eye image at the time of the second authentication has failed on an edge of a screen of the touch panel (operation member 123) or the display device 214 via the second presentation information determination unit 509 and the information presentation unit 510. FIG. 21 is a diagram illustrating an example of a display screen 2100 that is displayed in the display processing in step S1704 illustrated in FIG. 17. In the display screen 2100 illustrated in FIG. 21, a subject image that the image sensor 211 is capturing based on an operation performed by the user is being displayed. Then, as shown in the display screen 2100 illustrated in FIG. 21, in the display processing in step S1704 illustrated in FIG. 17, the second authentication unit 505 can display a message 2102, “Image capturing of an eye image is failed”, in an edge of a screen of the touch panel (operation member 123) or the display device 214. Moreover, in the display processing in step S1704 illustrated in FIG. 17, the second authentication unit 505 can display an icon 2101 indicating the failure of image capturing of an eye image in an edge of a screen of the touch panel (operation member 123) or the display device 214. When the processing operation in step S1704 illustrated in FIG. 17 has ended, the second authentication unit 505 returns the processing to step S1701.

Moreover, if, in step S1703 illustrated in FIG. 17, it is determined that the acquisition of an eye image is successful (YES in step S1703), the eye image acquisition unit 501 advances the processing to step S1705.

In step S1705 illustrated in FIG. 17, the second authentication unit 505 performs comparison processing between a registered image, which is a previously registered eye image, and an authentication image, which is the eye image acquired in step S1702.

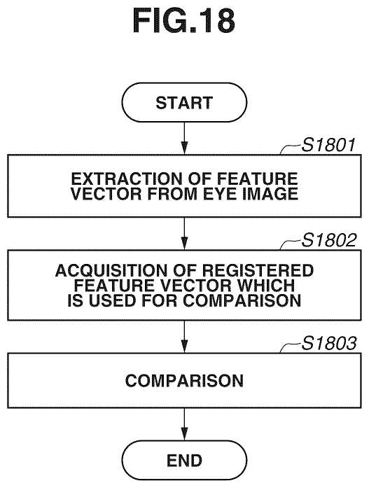

FIG. 18 is a flowchart illustrating an example of a detailed comparison processing procedure in step S1705 illustrated in FIG. 17.

First, in step S1801 illustrated in FIG. 18, the second authentication unit 505 performs extraction of a feature vector from the eye image acquired in step S1702. Here, for example, a neural network is used for the extraction of a feature vector, and the extracted feature vector is used for personal authentication of the user. Furthermore, the method of personal authentication of the user using an eye image is not limited to the above-mentioned method using a neural network, and, for example, a known method such as, for example, iris recognition can be used.

Next, in step S1802 illustrated in FIG. 18, the second authentication unit 505 acquires, from the registration data management unit 503, a registered feature vector that is used for the second authentication. Specifically, the second authentication unit 505 acquires all of the feature vectors shown in the second authentication registration data table 540 illustrated FIG. 5D.

Next, in step S1803 illustrated in FIG. 18, the second authentication unit 505 performs comparison between the feature vector targeted for authentication extracted in step S1801 and the registered feature vector acquired in step S1802. Specifically, the second authentication unit 505 obtains a cosine similarity of the two feature vectors and determines whether the obtained cosine similarity exceeds a preliminarily determined threshold value. Then, the second authentication unit 505 identifies a person ID with a registered feature vector the cosine similarity of which has exceeded the threshold value.

When the processing operation in step S1803 illustrated in FIG. 18 has ended, the processing illustrated in the flowchart of FIG. 18 ends. Then, when the processing illustrated in the flowchart of FIG. 18 has ended, the comparison processing in step S1705 illustrated in FIG. 17 ends.

Here, the description refers back to FIG. 17 again.

Next, in step S1706 illustrated in FIG. 17, the second authentication unit 505 determines whether the second authentication is successful. Specifically, in a case where there is a registered feature vector the cosine similarity of which has exceeded the threshold value in step S1705 illustrated in FIG. 17 (specifically, in step S1803 illustrated in FIG. 18), the second authentication unit 505 determines that the second authentication is successful.

If, in step S1706 illustrated in FIG. 17, it is determined that the second authentication is successful (YES in step S1706), the second authentication unit 505 advances the processing to step S1707.

In step S1707 illustrated in FIG. 17, the second authentication unit 505 performs processing for the time of success of authentication.

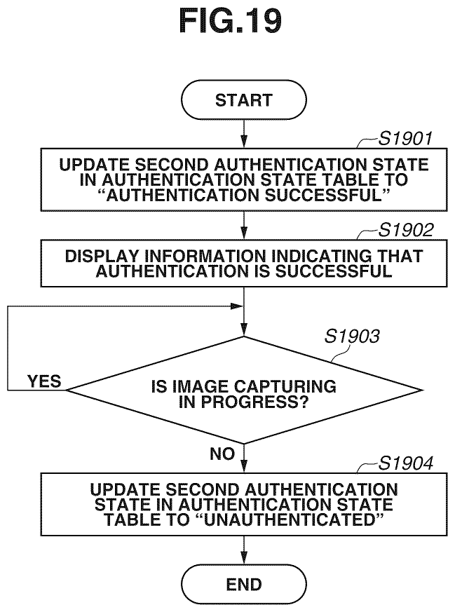

FIG. 19 is a flowchart illustrating an example of a detailed processing procedure for the time of success of authentication in step S1707 illustrated in FIG. 17.

In step S1901 illustrated in FIG. 19, the second authentication unit 505 causes the authentication state management unit 506 to update the second authentication state in the authentication state table 550 illustrated in FIG. 5E to “authentication successful.” Additionally, the second authentication unit 505 causes the authentication state management unit 506 to update the number of failures of second authentication shown in the authentication state table 550 illustrated in FIG. 5E to “0.”

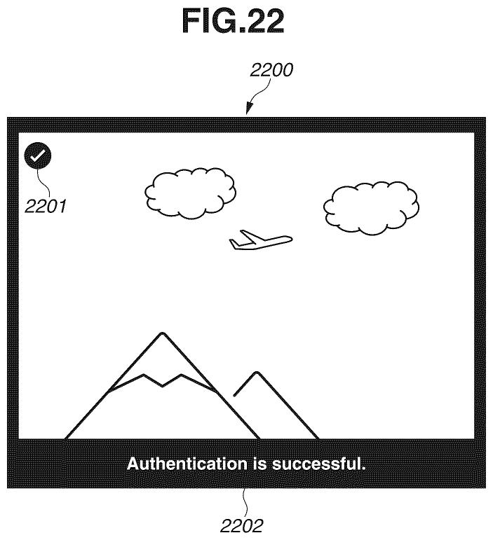

Next, in step S1902 illustrated in FIG. 19, the second authentication unit 505 displays information indicating that the second authentication is successful in an edge of a screen of the touch panel (operation member 123) or the display device 214 via the second presentation information determination unit 509 and the information presentation unit 510. FIG. 22 is a diagram illustrating an example of a display screen 2200 that is displayed in the display processing in step S1902 illustrated in FIG. 19.

In the display screen 2200 illustrated in FIG. 22, a subject image, which the image sensor 211 is capturing based on an operation performed by the user, is being displayed. Then, as shown in the display screen 2200 illustrated in FIG. 22, in the display processing in step S1902 illustrated in FIG. 19, the second authentication unit 505 can display a message 2202, “Authentication is successful,” or can display an icon 2201 that indicates the success of authentication.

Next, in step S1903 illustrated in FIG. 19, the second authentication unit 505 determines whether the user is continuing image capturing of a subject image (image capturing is in progress). A specific determination method in step S1903 is similar to that in step S1701 illustrated in FIG. 17 and is, therefore, omitted from description here.

If, in step S1903 illustrated in FIG. 19, it is determined that the user is continuing image capturing of a subject image (image capturing is in progress) (YES in step S1903), the second authentication unit 505 causes the processing to wait in step S1903.

Moreover, if, in step S1903 illustrated in FIG. 19, it is determined that the user is not continuing image capturing of a subject image (image capturing is not in progress) (NO in step S1903), the second authentication unit 505 advances the processing to step S1904.

In step S1904 illustrated in FIG. 19, the second authentication unit 505 causes the authentication state management unit 506 to update the second authentication state in the authentication state table 550 illustrated in FIG. 5E to “unauthenticated.”

When the processing operation in step S1904 illustrated in FIG. 19 has ended, the processing illustrated in the flowchart of FIG. 19 ends. Then, when the processing illustrated in the flowchart of FIG. 19 has ended, the processing for the time of success of authentication in step S1707 illustrated in FIG. 17 ends.

Here, the description refers back to FIG. 17 again.

When the processing operation in step S1707 illustrated in FIG. 17 has ended, the second authentication unit 505 advances the processing to step S1708. Moreover, if, in step S1701 illustrated in FIG. 17, it is determined that the first authentication is not in progress or the user is not continuing image capturing of a subject image (image capturing is not in progress) (NO in step S1701), the second authentication unit 505 advances the processing to step S1708.

In step S1708 illustrated in FIG. 17, the second authentication unit 505 updates displaying on the display device 214 via the second presentation information determination unit 509 and the information presentation unit 510. If image capturing is not in progress, the second authentication unit 505 does not perform displaying of the authentication state.

Moreover, if, in step S1706 illustrated in FIG. 17, it is determined that the second authentication is not successful (has failed) (NO in step S1706), the second authentication unit 505 advances the processing to step S1709.

In step S1709 illustrated in FIG. 17, the second authentication unit 505 performs processing for the time of failure of authentication.

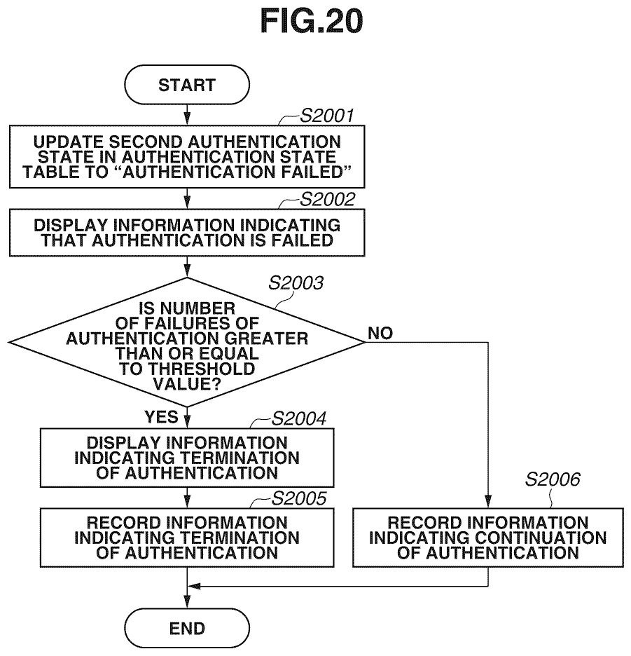

FIG. 20 is a flowchart illustrating an example of a detailed processing procedure for the time of failure of authentication in step S1709 illustrated in FIG. 17.

In step S2001 illustrated in FIG. 20, the second authentication unit 505 causes the authentication state management unit 506 to update the second authentication state in the authentication state table 550 illustrated in FIG. 5E to “authentication failed.” Additionally, the second authentication unit 505 causes the authentication state management unit 506 to update the number of failures of second authentication shown in the authentication state table 550 illustrated in FIG. 5E by adding “1” to the number of failures of second authentication.

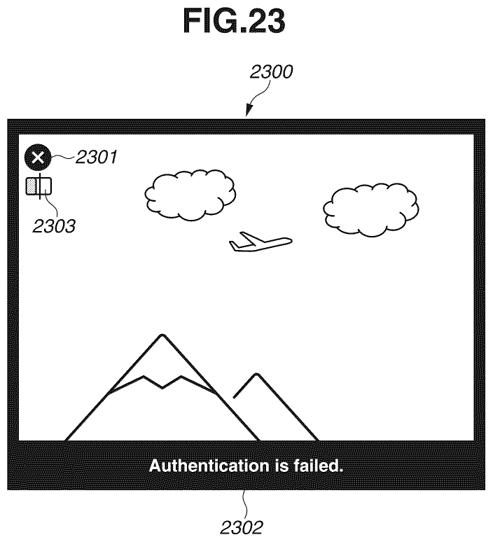

Next, in step S2002 illustrated in FIG. 20, the second authentication unit 505 displays information indicating that the second authentication has failed in an edge of a screen of the touch panel (operation member 123) or the display device 214 via the second presentation information determination unit 509 and the information presentation unit 510. FIG. 23 is a diagram illustrating an example of a display screen 2300 that is displayed in the display processing in step S2002 illustrated in FIG. 20.

In the display screen 2300 illustrated in FIG. 23, a subject image, which the image sensor 211 is capturing based on an operation performed by the user, is being displayed. Then, as shown in the display screen 2300 illustrated in FIG. 23, in the display processing in step S2002 illustrated in FIG. 20, the second authentication unit 505 can display a message 2302, “Authentication is failed,” or can display an icon 2301 which indicates the failure of authentication. Additionally, as shown in the display screen 2300 illustrated in FIG. 23, in the display processing in step S2002 illustrated in FIG. 20, the second authentication unit 505 can display an illustration 2303 indicating the cosine similarity obtained in step S1705 illustrated in FIG. 17 (specifically, step S1803 illustrated in FIG. 18) and the threshold value. While, in the display screen 2300 illustrated in FIG. 23, the cosine similarity and the threshold value are directly displayed in the illustration 2303, a display method that the user can easily understand, such as the method of, for example, converting the cosine similarity and the threshold value into integer values by multiplying them by respective constants and displaying the integer values, only needs to be employed.

Next, in step S2003 illustrated in FIG. 20, the second authentication unit 505 determines, via the authentication state management unit 506, whether the number of failures (the number of consecutive failures) of second authentication in the authentication state table 550 illustrated in FIG. 5E is greater than or equal to a predetermined second threshold value. Here, the second threshold value is assumed to be a positive integer and a fixed value, but it can be an optional threshold value that the user is allowed to set. The second threshold value for use in step S2003 illustrated in FIG. 20 is set to a value smaller than the first threshold value for use in step S1204 illustrated in FIG. 12 (in other words, the first threshold value for use in step S1204 illustrated in FIG. 12 is set to a value larger than the second threshold value for use in step S2003 illustrated in FIG. 20). With the second threshold value set in this way, in a case where the second authentication has consecutively failed at the time of image capturing of a subject image, the second authentication unit 505 early terminates UI displaying for authentication, thus being able to prevent or reduce a hindrance occurring in an image capturing operation for a subject image of the user at the time of the second authentication. This enables improving usability at the time of image capturing of a subject image.

If, in step S2003 illustrated in FIG. 20, it is determined that the number of failures (the number of consecutive failures) of second authentication in the authentication state table 550 illustrated in FIG. 5E is greater than or equal to the second threshold value (YES in step S2003), the second authentication unit 505 advances the processing to step S2004.

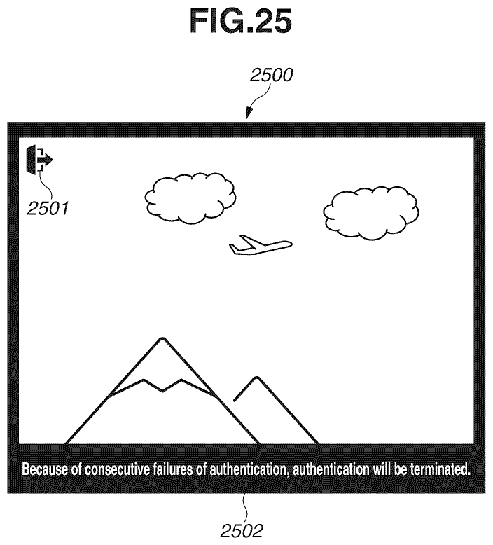

In step S2004 illustrated in FIG. 20, first, the second authentication unit 505 performs initialization by causing the authentication state management unit 506 to update the second authentication state in the authentication state table 550 illustrated in FIG. 5E to “unauthenticated” and also update the number of failures of second authentication to “0.” Next, in step S2004 illustrated in FIG. 20, the second authentication unit 505 displays information indicating that the second authentication unit 505 terminates the second authentication, in an edge of a screen of the touch panel (operation member 123) or the display device 214 via the second presentation information determination unit 509 and the information presentation unit 510. FIG. 25 is a diagram illustrating an example of a display screen 2500 that is displayed in the display processing in step S2004 illustrated in FIG. 20. In the display screen 2500 illustrated in FIG. 25, a subject image, which the image sensor 211 is capturing based on an operation performed by the user, is displayed. Then, as shown in the display screen 2500 illustrated in FIG. 25, in the display processing in step S2004 illustrated in FIG. 20, the second authentication unit 505 can display a message 2502, “Because of consecutive failures of authentication, authentication will be terminated,” or can display an icon 2501 indicating the termination of authentication.

Next, in step S2005 illustrated in FIG. 20, the second authentication unit 505 records information indicating that the second authentication unit 505 terminates the second authentication with, for example, a flag.

Moreover, if, in step S2003 illustrated in FIG. 20, it is determined that the number of failures (the number of consecutive failures) of second authentication in the authentication state table 550 illustrated in FIG. 5E is less than the second threshold value (NO in step S2003), the second authentication unit 505 advances the processing to step S2006.

In step S2006 illustrated in FIG. 20, the second authentication unit 505 records information indicating that the second authentication unit 505 continues the second authentication with, for example, a flag.

When the processing operation in step S2005 illustrated in FIG. 20 has ended or when the processing operation in step S2006 illustrated in FIG. 20 has ended, the processing illustrated in the flowchart of FIG. 20 ends. Then, when the processing illustrated in the flowchart of FIG. 20 has ended, the processing for the time of failure of authentication in step S1709 illustrated in FIG. 17 ends.

Here, the description refers back to FIG. 17.

Next, in step S1710 illustrated in FIG. 17, the second authentication unit 505 determines whether to terminate the second authentication processing. Specifically, based on the flag recorded in step S2005 or step S2006 illustrated in FIG. 20, the second authentication unit 505 determines whether to terminate the second authentication processing.

If, in step S1710 illustrated in FIG. 17, it is determined not to terminate (it is determined to continue) the second authentication processing (NO in step S1710), the second authentication unit 505 returns the processing to step S1701 and then performs processing operations in step S1701 and subsequent steps again.

Moreover, if, in step S1710 illustrated in FIG. 17, it is determined to terminate the second authentication processing (YES in step S1710) or if the processing operation in step S1708 illustrated in FIG. 17 has ended, the second authentication unit 505 ends the processing illustrated in the flowchart of FIG. 17.

The image capturing apparatus 100 according to the above-described first embodiment includes the following configurations.

Specifically, the image capturing apparatus 100 according to the first embodiment includes an image sensor 211 (a first image capturing unit) configured to capture a subject image based on an operation performed by a user, and an eye image sensor 219 (a second image capturing unit) configured to capture an eye image including an eye (eyeball) E of the user as an authentication image. Moreover, the image capturing apparatus 100 according to the first embodiment includes a first authentication unit 504 configured to perform authentication of the user based on the eye image obtained by the eye image sensor 219 before capturing of the subject image by the image sensor 211. Moreover, the image capturing apparatus 100 according to the first embodiment includes a second authentication unit 505 configured to perform authentication of the user based on the eye image obtained by the eye image sensor 219 during capturing of the subject image by the image sensor 211. Then, the image capturing apparatus 100 according to the first embodiment includes an information presentation unit 510 configured to present information to the user. Specifically, the information presentation unit 510 presents, to the user, first presentation information including guidance information for guiding at least one of a position and direction of the eye (eyeball) E of the user during capturing of the eye image by the eye image sensor 219 when authentication of the user is performed by the first authentication unit 504. Moreover, the information presentation unit 510 presents, to the user, second presentation information related to authentication processing by the second authentication unit 505 during capturing of the eye image by the eye image sensor 219 when authentication of the user is performed by the second authentication unit 505.

According to such a configuration, it is possible to acquire an authentication image in such a manner that reduces a change in appearance between the authentication image and a registered image while ensuring usability at the time of image capturing using the image capturing apparatus 100 (for example, at the time of capturing of a subject image).

In the first embodiment, at the time of the first authentication, the information presentation unit 510 presents, to the user, the guidance information as the first presentation information in such a way as to bring the state of the eye (eyeball) E of the user into a desirable state both before authentication and at the time of failure of authentication (step S903 illustrated in FIG. 9, step S1208 illustrated in FIG. 12, and FIGS. 14A and 14B). This causes a strict check to be performed at the time of the first authentication and thus enables increasing the authentication accuracy of the first authentication.

Moreover, in the first embodiment, at the time of the second authentication, the information presentation unit 510 does not present, to the user, the guidance information as the second presentation information, and thus prevents or reduces a hindrance occurring in an image capturing operation for a subject image of the user and further increases usability at the time of image capturing of a subject image. In this way, in the first embodiment, the second presentation information, which is presented at the time of the second authentication, is set as presentation information different from the first presentation information, which is presented at the time of the first authentication.

With the image capturing apparatus 100 according to the first embodiment, it is possible to acquire an authentication image that satisfies criteria differing between the first authentication and the second authentication while ensuring usability at the time of image capturing using the image capturing apparatus 100 (for example, at the time of capturing of a subject image).

Moreover, in the first embodiment, with regard to threshold values for the number of consecutive failures before the termination of authentication processing, the second threshold value for the second authentication is set as a value smaller than the first threshold value for the first authentication. With this setting, it is possible to earlier terminate UI displaying for authentication in a case where the second authentication is consecutively failed than in a case where the first authentication is consecutively failed, and, thus, it is possible to prevent or reduce a hindrance occurring in an image capturing operation for a subject image of the user at the time of the second authentication. This enables further improving usability at the time of capturing of a subject image.

Moreover, in the first embodiment, at the time of the second authentication, the information presentation unit 510 displays second presentation information including the state of authentication and the success or failure of authentication in an edge of a screen of a display unit (FIG. 21 to FIG. 23 and FIG. 25). This enables displaying a subject image in the screen of the display unit without the subject image being hindered by the second presentation information and thus enables further improving usability at the time of capturing of a subject image.

### Modification Example 1 of First Embodiment

If the position of the eye (eyeball) E of the user differs between the time of registration and the time of authentication, the authentication rate may decrease. In this respect, in modification example 1 of the first embodiment, a configuration is described in which guidance is performed in such a manner that, at the time of failure of eye image acquisition and at the time of failure of authentication in the first authentication, the position of the eye (eyeball) E of the user becomes the same as that obtained at the time of registration and thus increases the quality of an authentication image and increases the authentication accuracy of the first authentication.

In the above-described first embodiment, in the processing operation for the time of failure of eye image acquisition and the processing operation for the time of failure of authentication in the first authentication, the eyeball state acquisition unit 507 acquires line-of-sight information as the current state of the eye (eyeball) E of the user, but also can acquire the position of the eye (eyeball) E of the user.

Specifically, in step S902 illustrated in FIG. 9 and step S1207 illustrated in FIG. 12, the eyeball state acquisition unit 507 detects an eyeball by a known technical method from an eye image acquired by the eye image acquisition unit 501 and sets the coordinates of the center of the detected eyeball as current eyeball position coordinates C1. Moreover, the eyeball state acquisition unit 507 detects an eyeball by a similar method from each eye image in the first authentication registration data table 530 illustrated in FIG. 5C and sets the coordinates of the center of the detected eyeball as registered eyeball position coordinates C2. Here, the eyeball state acquisition unit 507 can perform processing for detecting the registered eyeball position coordinates C2 at the time of registration processing for an eye image. Then, the eyeball state acquisition unit 507 can calculate the direction of a vector from the current eyeball position coordinates C1 to the registered eyeball position coordinates C2.

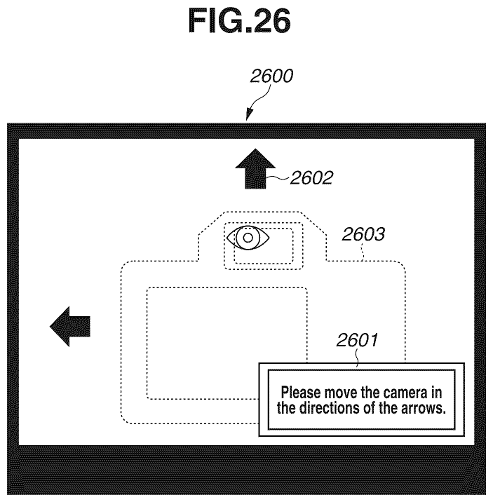

FIG. 26 is a diagram illustrating an example of a display screen 2600 for displaying guidance information included in the first presentation information in modification example 1 of the first embodiment. In step S903 illustrated in FIG. 9 and step S1208 illustrated in FIG. 12, the first authentication unit 504 is able to display the display screen 2600 illustrated in FIG. 26 via the first presentation information determination unit 508 and the information presentation unit 510. Specifically, as shown in the display screen 2600 illustrated in FIG. 26, the first authentication unit 504 displays a message 2601 for guiding the eye access position of the user in the above-mentioned calculated direction of the vector, an illustration 2603 indicating the eye access position, and an arrow 2602 on the touch panel (operation member 123) or the display device 214. By performing displaying as shown in the display screen 2600 illustrated in FIG. 26, the first authentication unit 504 is able to bring the position of the eye (eyeball) E of the user closer to the position of the eye (eyeball) E of the eye image in the first authentication registration data table 530, thus enabling increased quality of an authentication image.

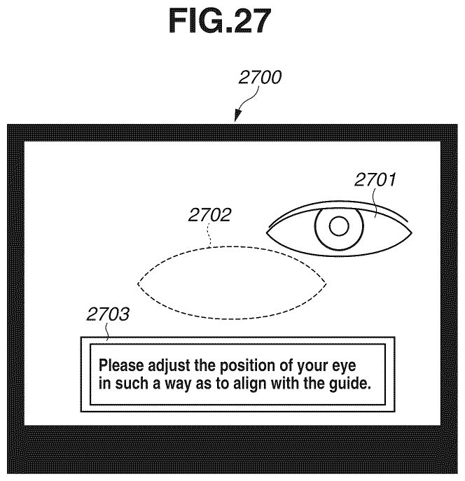

FIG. 27 is a diagram illustrating an example of a display screen 2700 for displaying guidance information included in the first presentation information in modification example 1 of the first embodiment. In step S903 illustrated in FIG. 9 and step S1208 illustrated in FIG. 12, the first authentication unit 504 is able to display the display screen 2700 illustrated in FIG. 27 via the first presentation information determination unit 508 and the information presentation unit 510. Specifically, as shown in the display screen 2700 illustrated in FIG. 27, the first authentication unit 504 displays, in real time, an icon 2701 indicating the current eyeball position coordinates C1 on the touch panel (operation member 123) or the display device 214.

Moreover, as shown in the display screen 2700 illustrated in FIG. 27, the first authentication unit 504 displays a guide 2702 indicating the registered eyeball position coordinates C2 and a message 2703 for issuing an instruction to align the position of the eye (eyeball) E with the guide 2702 on the touch panel (operation member 123) or the display device 214. By performing displaying as shown in the display screen 2700 illustrated in FIG. 27, the first authentication unit 504 enables the user to intuitively adjust the position of the eye (eyeball) E of the user to the position of the eye (eyeball) E of the eye image in the first authentication registration data table 530 and thus enables increased quality of an authentication image.

According to modification example 1 of the first embodiment, it is possible to perform guidance in such a manner that, for example, at the time of failure of authentication in the first authentication, the position of the eye (eyeball) E of the user becomes the same as that obtained at the time of registration and, thus, it is possible to increase the quality of an authentication image and increase the authentication accuracy of the first authentication.

### Modification Example 2 of First Embodiment

If the eye access distance and eye access angle of the eye (eyeball) E of the user differ between the time of registration and the time of authentication, the authentication rate may decrease. In this respect, in modification example 2 of the first embodiment, a configuration is described in which guidance is performed in such a manner that, at the time of failure of eye image acquisition and at the time of failure of authentication in the first authentication, the eye access distance and eye access angle of the eye (eyeball) E of the user become the same as those obtained at the time of registration and thus increases the quality of an authentication image and increases the authentication accuracy of the first authentication.

In the above-described first embodiment, in the processing operation for the time of failure of eye image acquisition and the processing operation for the time of failure of authentication in the first authentication, the eyeball state acquisition unit 507 acquires line-of-sight information as the current state of the eye (eyeball) E of the user, but also can acquire the eye access distance and the eye access angle.

Specifically, in step S902 illustrated in FIG. 9 and step S1207 illustrated in FIG. 12, the eyeball state acquisition unit 507 calculates the distance between the image capturing apparatus 100 and the eye (eyeball) E of the user as the current eye access distance with use of an output value of the eyepiece sensor 221. Moreover, the eyeball state acquisition unit 507 calculates the current eye access angle from the eye image acquired by the eye image acquisition unit 501 with use of, for example, a method described in Japanese Patent Laid-Open No. 2024-2562. Moreover, in step S611 illustrated in FIG. 6 for the registration processing, the eyeball state acquisition unit 507 calculates an eye access distance and an eye access angle which correspond to the feature vector with use of a similar method and preliminarily registers the calculated eye access distance and eye access angle with the first authentication registration data table 530. Then, the eyeball state acquisition unit 507 is able to calculate, from the current eye access distance and the eye access distance in the first authentication registration data table 530, a direction which brings the current eye access distance close to the eye access distance in the first authentication registration data table 530.

Moreover, the eyeball state acquisition unit 507 is able to calculate, from the current eye access angle and the eye access angle in the first authentication registration data table 530, a direction which brings the current eye access angle close to the eye access angle in the first authentication registration data table 530.

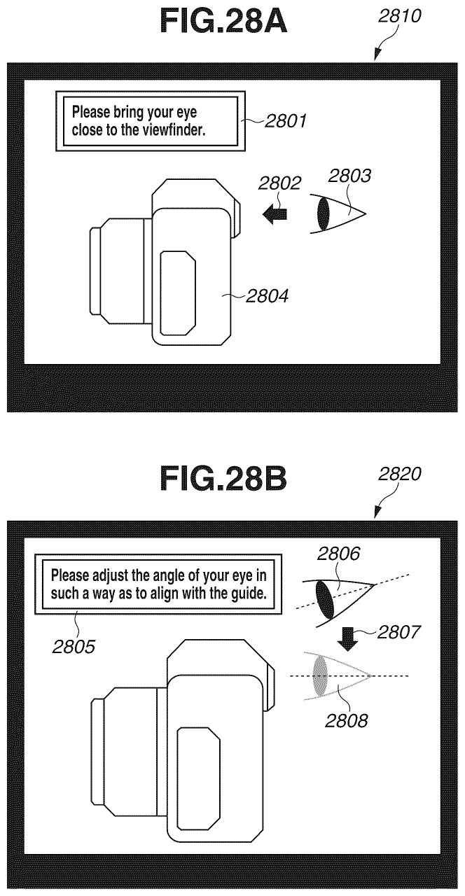

FIGS. 28A and 28B are diagrams illustrating examples of display screens 2810 and 2820 for displaying guidance information included in the first presentation information in modification example 2 of the first embodiment. In step S903 illustrated in FIG. 9 and step S1208 illustrated in FIG. 12, the first authentication unit 504 is able to display the display screen 2810 illustrated in FIG. 28A and the display screen 2820 illustrated in FIG. 28B via the first presentation information determination unit 508 and the information presentation unit 510.

Specifically, as shown in the display screen 2810 illustrated in FIG. 28A, the first authentication unit 504 displays a message 2801 for guiding the eye access distance for the user on the touch panel (operation member 123) or the display device 214. Additionally, as shown in the display screen 2810 illustrated in FIG. 28A, the first authentication unit 504 displays an arrow 2802 indicating the direction for adjusting the eye access distance between an illustration 2803 of the eyeball of the user and an illustration 2804 of the image capturing apparatus 100 on the touch panel (operation member 123) or the display device 214. By performing displaying as shown in the display screen 2810 illustrated in FIG. 28A, the first authentication unit 504 enables the user to adjust the eye access distance and thus enables increasing the quality of an authentication image.

Moreover, as shown in the display screen 2820 illustrated in FIG. 28B, the first authentication unit 504 displays a message 2805 for prompting the user to adjust the eye access angle of the user on the touch panel (operation member 123) or the display device 214. Moreover, as shown in the display screen 2820 illustrated in FIG. 28B, the first authentication unit 504 displays an illustration 2806 representing the current eye access angle of the user, an illustration 2808 representing the target eye access angle, and an arrow 2807 representing a direction for adjusting the eye access angle on the touch panel (operation member 123) or the display device 214. By performing displaying as shown in the display screen 2820 illustrated in FIG. 28B, the first authentication unit 504 enables the user to adjust the eye access angle and thus enables increasing the quality of an authentication image.

According to modification example 2 of the first embodiment, for example, at the time of failure of authentication in the first authentication, it is possible to bring the eye access distance and eye access angle of the eye (eyeball) E of the user closer to those obtained at the time of registration and, thus, it is possible to increase the quality of an authentication image and increase the authentication accuracy of the first authentication.

### Modification Example 3 of First Embodiment

If the wearing condition of eyewear such as eyeglasses or sunglasses by the user differs between the time of registration and the time of authentication, the authentication rate may decrease. In this respect, in modification example 3 of the first embodiment, a configuration is described in which guidance is performed in such a manner that, at the time of failure of eye image acquisition and at the time of failure of authentication in the first authentication, the wearing condition of eyewear by the user becomes the same as that obtained at the time of registration and thus increases the quality of an authentication image and increases the authentication accuracy of the first authentication.

In the above-described first embodiment, in the processing operation for the time of failure of eye image acquisition and the processing operation for the time of failure of authentication in the first authentication, the eyeball state acquisition unit 507 acquires line-of-sight information as the current state of the eye (eyeball) E of the user, but also can acquire the wearing condition of eyewear by the user.

Specifically, in step S902 illustrated in FIG. 9 and step S1207 illustrated in FIG. 12, the eyeball state acquisition unit 507 determines a wearing condition E1 of eyewear by a known technical method from an eye image acquired by the eye image acquisition unit 501. Moreover, the eyeball state acquisition unit 507 determines a wearing condition E2 of eyewear by a similar method from the eye image in the first authentication registration data table 530 illustrated in FIG. 5C. Here, the eyeball state acquisition unit 507 can perform processing for determining the wearing condition E2 at the time of registration processing for an eye image.

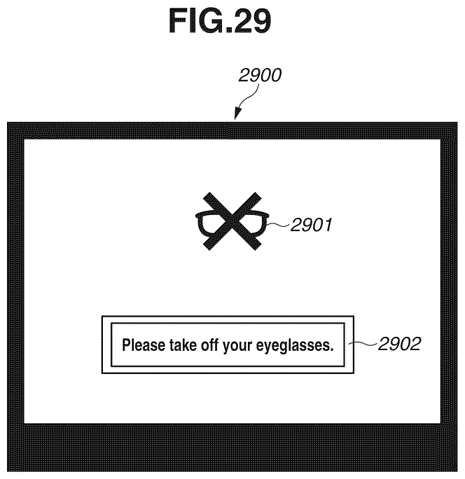

FIG. 29 is a diagram illustrating an example of a display screen 2900 for displaying guidance information included in the first presentation information in modification example 3 of the first embodiment. In step S903 illustrated in FIG. 9 and step S1208 illustrated in FIG. 12, in a case where the wearing condition E1 and the wearing condition E2 are different from each other, the first authentication unit 504 is able to display the display screen 2900 illustrated in FIG. 29 via the first presentation information determination unit 508 and the information presentation unit 510. Specifically, as shown in the display screen 2900 illustrated in FIG. 29, the first authentication unit 504 displays a message 2902 and an icon 2901, which guide the user in such a manner that the wearing condition E1 and the wearing condition E2 become the same on the touch panel (operation member 123) or the display device 214. By performing displaying as shown in the display screen 2900 illustrated in FIG. 29, the first authentication unit 504 is able to bring the wearing condition of eyewear by the user close to that obtained at the time of registration and thus enables increasing the quality of an authentication image.

According to modification example 3 of the first embodiment, it is possible to perform guidance in such a manner that, for example, at the time of failure of authentication in the first authentication, the wearing condition of eyewear by the user becomes the same as that obtained at the time of registration and, thus, it is possible to increase the quality of an authentication image and increase the authentication accuracy of the first authentication.

### Modification Example 4 of First Embodiment

In modification example 4 of the first embodiment, a configuration is described in which the first presentation information and the second presentation information are presented to the user with use of sound outputting performed by the loudspeaker 220, which is an example of a sound output unit, and thus increases usability.

In the above-described first embodiment, a configuration in which the information presentation unit 510 displays the first presentation information and the second presentation information on a display unit of the touch panel (operation member 123) or the display device 214 has been described.

In modification example 4 of the first embodiment, the information presentation unit 510 causes the loudspeaker 220 to perform sound outputting of the first presentation information and the second presentation information as audio guides. In this case, the contents of the audio guides can be output by performing reading of a message that is displayed on the display unit, and, in a case where an arrow is displayed on the display unit, the direction of the displayed arrow can be described in words to be subjected to sound outputting as an audio guide.

According to modification example 4 of the first embodiment, it is possible to increase usability.

### Modification Example 5 of First Embodiment

In modification example 5 of the first embodiment, a configuration is described in which, when, at the time of failure of eye image acquisition and at the time of failure of authentication in the first authentication, guiding the user in such a way as to prompt the user to gaze at the index, the user is shown a time for which the user ought to gaze at the index and thus increases the effect of guiding the user.

In the above-described first embodiment, a configuration has been described in which, in step S903 illustrated in FIG. 9 serving as the processing for the time of failure of eye image acquisition in the first authentication and step S1208 illustrated in FIG. 12 serving as the processing for the time of failure of authentication in the first authentication, the information presentation unit 510 displays a message 1403 illustrated in FIG. 14A and FIG. 14B for guiding the user in such a way as to prompt the user to gaze at the index.

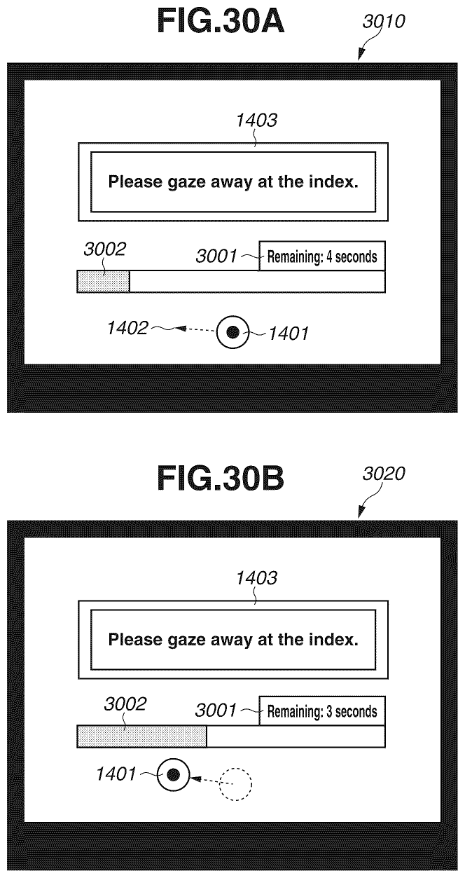

FIGS. 30A and 30B are diagrams illustrating examples of display screens 3010 and 3020 for displaying guidance information included in the first presentation information in modification example 5 of the first embodiment. In FIGS. 30A and 30B, the same constituent elements as the constituent elements illustrated in FIGS. 14A and 14B are assigned the respective same reference characters as those in FIGS. 14A and 14B and the detailed description thereof is omitted here. In step S903 illustrated in FIG. 9 and step S1208 illustrated in FIG. 12, the first authentication unit 504 is able to display the display screen 3010 illustrated in FIG. 30A or the display screen 3020 illustrated in FIG. 30B via the first presentation information determination unit 508 and the information presentation unit 510.

Specifically, as shown in the display screen 3010 illustrated in FIG. 30A and the display screen 3020 illustrated in FIG. 30B, the first authentication unit 504 can display a message 3001 indicating the remaining time of a gaze time or can display a progress bar 3002. In this case, the gaze time can be a fixed value or can be an optional value that the user is allowed to set.

According to modification example 5 of the first embodiment, because it is possible to increase the effect of guiding the user, it is possible to increase the quality of an authentication image and thus increase the authentication accuracy of the first authentication.

### Modification Example 6 of First Embodiment

In modification example 6 of the first embodiment, a configuration is described in which, at the time of failure of eye image acquisition and at the time of failure of authentication in the first authentication, the user is presented with an eyeball state score indicating a difference between the current state of the eye (eyeball) E and the state thereof obtained at the time of registration and thus increases the effect of guiding the user.

In the above-described first embodiment, in the processing for the time of failure of eye image acquisition and the processing for the time of failure of authentication in the first authentication, the eyeball state acquisition unit 507 acquires the current state of the eye (eyeball) E, but also can further acquire the above-mentioned eyeball state score.

For example, in a case where line-of-sight information is already acquired as the current state of the eye (eyeball) E of the user, when the above-mentioned eyeball state score is denoted by S, the eyeball state acquisition unit 507 uses a function f of “S=f(D)” to acquire the eyeball state score S. Here, the function f is a function that takes a higher value as the distance D is closer to 0 and that decreases in proportion to the distance D. Here, the function f can be defined by, for example, f(D)=1/(D+ε). In this case, ε is a minute value for preventing division by zero. From the viewpoint of understandability, the eyeball state score S can be normalized in such a way as to be expressed within the range of 0 to 100. Furthermore, the function that is used for acquisition of the eyeball state score S is not limited to the above-mentioned function if the qualitative property thereof is unvarying. Moreover, the method of calculating the eyeball state score S is not limited to the method using the distance D but can be another method as long as it is a method which indicates a difference between the current state of the eye (eyeball) E of the user and the state thereof obtained at the time of registration.

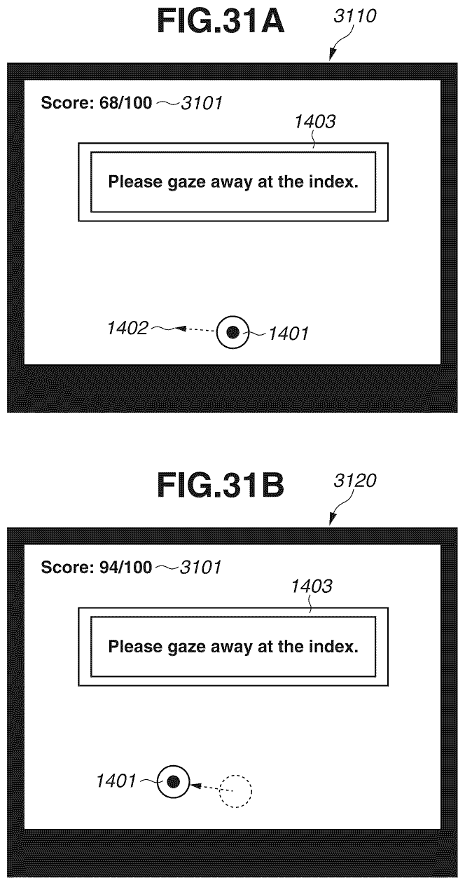

FIGS. 31A and 31B are diagrams illustrating examples of display screens 3110 and 3120 for displaying guidance information included in the first presentation information in modification example 6 of the first embodiment. In FIGS. 31A and 31B, the same constituent elements as the constituent elements illustrated in FIGS. 14A and 14B are assigned the respective same reference characters as those in FIGS. 14A and 14B and the detailed description thereof is omitted here. In step S903 illustrated in FIG. 9 and step S1208 illustrated in FIG. 12, the first authentication unit 504 is able to display the display screen 3110 illustrated in FIG. 31A or the display screen 3120 illustrated in FIG. 31B via the first presentation information determination unit 508 and the information presentation unit 510.

Specifically, as shown in the display screen 3110 illustrated in FIG. 31A and the display screen 3120 illustrated in FIG. 31B, the first authentication unit 504 displays an eyeball state score 3101 equivalent to the above-mentioned eyeball state score S in real time on the touch panel (operation member 123) or the display device 214.

According to modification example 6 of the first embodiment, because the user is able to intuitively adjust the line of sight of the eye (eyeball) E, it is possible to increase the quality of an authentication image and thus increase the authentication accuracy of the first authentication.

### Second Embodiment

Next, a second embodiment is described. Furthermore, in the description of the following second embodiment, particulars which are in common with those in the above-described first embodiment are omitted from the description here, and particulars that are different from those in the above-described first embodiment are described.

The outline configuration of an image capturing apparatus according to the second embodiment is the same as the outline configuration of the image capturing apparatus 100 according to the first embodiment illustrated in FIGS. 1A/1B to FIG. 3 and FIG. 5A.

In the second embodiment, the processing illustrated in the flowcharts of FIG. 6 to FIG. 12 and the processing illustrated in the flowcharts of FIG. 17 to FIG. 19 are the same as those in the above-described first embodiment. In the second embodiment, processing for the time of failure of authentication in the second authentication processing is different from that in the first embodiment illustrated in FIG. 20.

In the above-described first embodiment, a configuration is employed in which, at the time of failure of authentication in the first authentication processing, in order to increase the quality of an authentication image, the information presentation unit 510 presents first presentation information including guidance information for guiding at least one of the position or direction of the eye (eyeball) E of the user. In this respect, in the second embodiment, a configuration is employed in which, not only at the time of failure of authentication in the first authentication processing but also at the time of failure of authentication in the second authentication processing, the information presentation unit 510 presents second presentation information including the above-mentioned guidance information while not hindering an image capturing operation for a subject image by the user as much as possible. With this configuration, even in the second embodiment, while ensuring usability at the time of image capturing of a subject image, it is possible to increase the quality of an authentication image in the second authentication and thus increase the authentication accuracy of the second authentication.

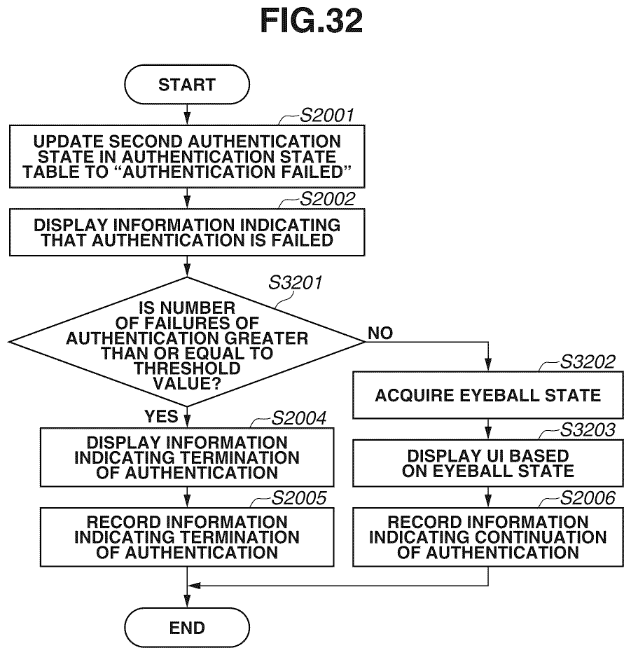

FIG. 32 is a flowchart illustrating an example of a detailed processing procedure for the time of failure of authentication in step S1709 illustrated in FIG. 17 in the second embodiment. In FIG. 32, the same processing steps as the processing steps illustrated in FIG. 20 are assigned the respective same step numbers as those in FIG. 20, and the detailed description thereof is omitted here.

In step S2001 illustrated in FIG. 32, as with step S2001 illustrated in FIG. 20, the second authentication unit 505 causes the authentication state management unit 506 to update the second authentication state in the authentication state table 550 illustrated in FIG. 5E to “authentication failed.” Additionally, the second authentication unit 505 causes the authentication state management unit 506 to update the number of failures of second authentication shown in the authentication state table 550 illustrated in FIG. 5E by adding “1” to the number of failures of second authentication.

Next, in step S2002 illustrated in FIG. 32, as with step S2002 illustrated in FIG. 20, the second authentication unit 505 displays information indicating that the second authentication has failed in an edge of a screen of the touch panel (operation member 123) or the display device 214 via the second presentation information determination unit 509 and the information presentation unit 510.

Next, in step S3201 illustrated in FIG. 32, the second authentication unit 505 determines, via the authentication state management unit 506, whether the number of failures (the number of consecutive failures) of second authentication in the authentication state table 550 illustrated in FIG. 5E is greater than or equal to a predetermined second threshold value.

If, in step S3201 illustrated in FIG. 32, it is determined that the number of failures (the number of consecutive failures) of second authentication in the authentication state table 550 illustrated in FIG. 5E is greater than or equal to the second threshold value (YES in step S3201), the second authentication unit 505 advances the processing to step S2004.

In step S2004 and subsequent steps illustrated in FIG. 32, the second authentication unit 505 performs processing operations similar to those in step S2004 and subsequent steps illustrated in FIG. 20, and then ends the processing illustrated in the flowchart of FIG. 32.

Moreover, if, in step S3201 illustrated in FIG. 32, it is determined that the number of failures (the number of consecutive failures) of second authentication in the authentication state table 550 illustrated in FIG. 5E is less than the second threshold value (NO in step S3201), the second authentication unit 505 advances the processing to step S3202.

In step S3202 illustrated in FIG. 32, the eyeball state acquisition unit 507 acquires the state of the eye (eyeball) E of the user from the eye image acquired in step S1702 illustrated in FIG. 17. Here, it is assumed that the eyeball state acquisition unit 507 acquires line-of-sight information about the user as the state of the eye (eyeball) E of the user.

Next, in step S3203 illustrated in FIG. 32, the information presentation unit 510 displays, via the second presentation information determination unit 509, a user interface (UI) based on the second authentication registration data table 540 illustrated in FIG. 5D and the state of the eye (eyeball) E of the user acquired in step S3202. Specifically, in a case where the eyeball state acquisition unit 507 acquires line-of-sight information about the user as the state of the eye (eyeball) E of the user, the second presentation information determination unit 509 determines a UI for guiding the line of sight of the user. Then, the information presentation unit 510 displays the UI determined by the second presentation information determination unit 509 on the touch panel (operation member 123) or the display device 214.

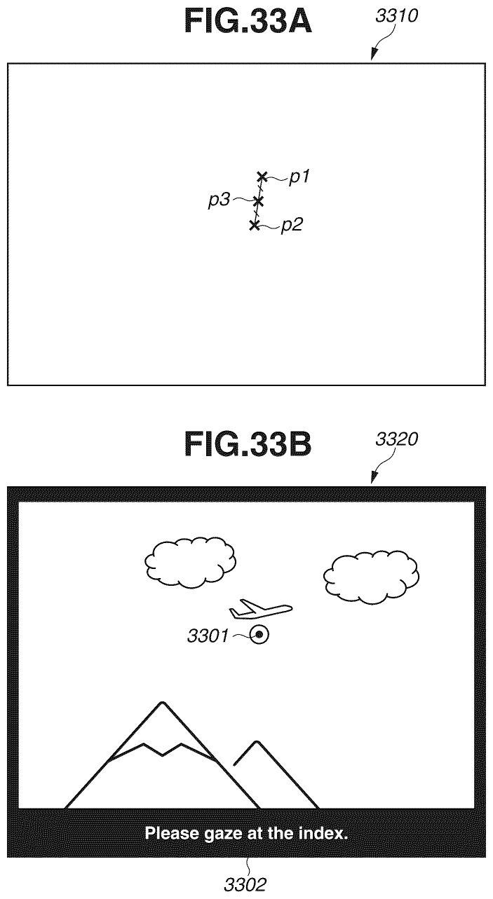

FIGS. 33A and 33B are diagrams illustrating examples of display screens 3310 and 3320, which are displayed in the display processing in step S3203 illustrated in FIG. 32. First, in the screen 3310 illustrated in FIG. 33A, the second presentation information determination unit 509 sets the current line-of-sight position of the user as the position “p1=(x1, y1)”. Then, the second presentation information determination unit 509 selects, from among the index positions in the second authentication registration data table 540, the index position the distance of which from position p1 is smallest, and sets the selected index position as the position “p2=(x2, y2)” in the screen 3310 illustrated in FIG. 33A. Then, as illustrated in FIG. 33A, the second presentation information determination unit 509 calculates, as a midpoint between position p1 and position p2, the position “p3=((x1+x2)/2, (y1+y2)/2).” The information presentation unit 510 displays an index 3301 at a position equivalent to position p3 illustrated in FIG. 33A, as shown in the display screen 3320 illustrated in FIG. 33B. Additionally, as shown in the display screen 3320 illustrated in FIG. 33B, the information presentation unit 510 displays a message 3302 for guiding the user in such way as to cause the user to gaze at the index 3301 in an edge of a screen of the display screen 3320. Thus, the information presentation unit 510 displays (presents) second presentation information including the index 3301 and the message 3302 illustrated in FIG. 33B serving as the above-mentioned guidance information. Furthermore, here, position p3 is defined as the position of a midpoint between position p1 and position p2, but can be set as a position obtained by weighting and averaging position p1 and position p2. Then, guiding the line of sight of the user to the position of the index 3301 illustrated in FIG. 33B enables bringing the line of sight of the user closer to the index position in the second authentication registration data table 540 and thus enables increasing the quality of an authentication image in the second authentication. Moreover, displaying the index 3301 at a position near the current line-of-sight position (p1) enables reducing a line-of-sight movement of the user at the time of an image capturing operation for a subject image and thus enables preventing or reducing a hindrance occurring in the image capturing operation for a subject image by the user.

When the processing operation in step S3203 illustrated in FIG. 32 has ended, the second authentication unit 505 advances the processing to step S2006.

In step S2006 illustrated in FIG. 32, the second authentication unit 505 performs a processing operation similar to that in step S2006 illustrated in FIG. 20, and then ends the processing illustrated in the flowchart of FIG. 32.

Furthermore, in the second embodiment, the second presentation information determination unit 509 does not need to determine guidance information as the second presentation information before the second authentication unit 505 performs authentication processing for the user.

According to the second embodiment, at the time of failure of authentication in the second authentication processing, displaying a UI for guiding the line of sight of the user while not hindering an image capturing operation for a subject image by the user as much as possible enables increasing the quality of an authentication image in the second authentication. This enables, while ensuring usability at the time of image capturing of a subject image, increasing the authentication accuracy of the second authentication.

### Modification Example 1 of Second Embodiment

In modification example 1 of the second embodiment, a configuration is described in which, at the time of failure of authentication in the second authentication, a gaze index is displayed at a midpoint between the current focusing frame and the line-of-sight position obtained at the time of registration and thus increases the authentication accuracy of the second authentication while ensuring usability at the time of image capturing of a subject image.

While, in step S3203 illustrated in FIG. 32 in the second embodiment, the current line-of-sight position is set as position p1, the current position of the focusing frame can be set as position p1.

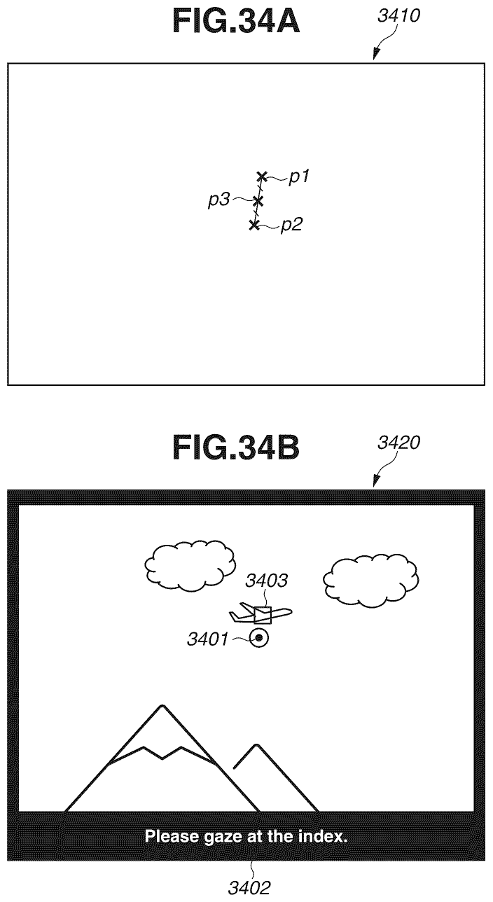

FIGS. 34A and 34B are diagrams illustrating examples of display screens 3410 and 3420, which are displayed in the display processing in step S3203 illustrated in FIG. 32 in modification example 1 of the second embodiment. Specifically, as shown in the display screen 3420 illustrated in FIG. 34B, the second presentation information determination unit 509 sets a distance measuring point index corresponding to the current point of view as a focusing frame 3403.

In the screen 3410 illustrated in FIG. 34A, the second presentation information determination unit 509 sets the center position of the focusing frame 3403 illustrated in FIG. 34B as the position “p1=(x1, y1),” and then selects, from among the index positions in the second authentication registration data table 540, the index position the distance of which from position p1 is smallest and sets the selected index position as the position “p2=(x2, y2)”. Then, as illustrated in FIG. 34A, the second presentation information determination unit 509 calculates, as a midpoint between position p1 and position p2, the position “p3=((x1+x2)/2, (y1+y2)/2)”. The information presentation unit 510 displays an index 3401 at a position equivalent to position p3 illustrated in FIG. 34A, as shown in the display screen 3420 illustrated in FIG. 34B. Additionally, as shown in the display screen 3420 illustrated in FIG. 34B, the information presentation unit 510 displays a message 3402 for guiding the user in such way as to prompt the user to gaze at the index 3401 in an edge of a screen of the display screen 3420. Thus, the information presentation unit 510 displays (presents) second presentation information including the index 3401 and the message 3402 illustrated in FIG. 34B serving as the above-mentioned guidance information. Furthermore, here, position p3 is defined as the position of a midpoint between position p1 and position p2, but can be set as, for example, a position obtained by weighting and averaging position p1 and position p2.

According to modification example 1 of the second embodiment, guiding the line of sight of the user to the position of the index 3401 enables bringing the line of sight closer to the position thereof obtained at the time of registration and thus enables increasing the quality of an authentication image in the second authentication. This enables, while ensuring usability at the time of image capturing of a subject image, increasing the authentication accuracy of the second authentication. Moreover, displaying the index 3401 at a position near an image capturing target object enables reducing a line-of-sight movement at the time of an image capturing operation for a subject image and thus enables further increasing usability at the time of image capturing of a subject image.

### Modification Example 2 of Second Embodiment

In modification example 2 of the second embodiment, a configuration is described in which, at the time of failure of authentication in the second authentication, the user is guided in such a way as to prompt the user to gaze at UI parts for image capturing in a position closest to the line-of-sight position obtained at the time of registration and thus increases the authentication accuracy of the second authentication while ensuring usability at the time of image capturing of a subject image.

In step S3203 illustrated in FIG. 32 in the second embodiment, the information presentation unit 510 displays an index and guides the user in such a way as to prompt the user to gaze at the index. In a case where the display device 214 is displaying a distance measuring point index and a focusing frame, the information presentation unit 510 can guide the user in such a way as to prompt the user to gaze at the distance measuring point index and the focusing frame.

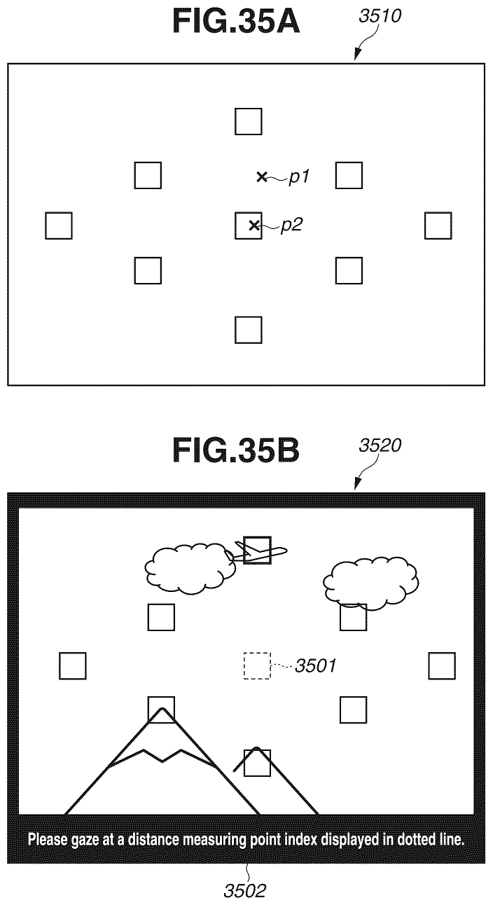

FIGS. 35A and 35B are diagrams illustrating examples of display screens 3510 and 3520, which are displayed in the display processing in step S3203 illustrated in FIG. 32 in modification example 2 of the second embodiment. Specifically, the second presentation information determination unit 509 obtains position p1 and position p2 shown in the screen 3510 illustrated in FIG. 35A with use of a method similar to the above-mentioned method in the second embodiment. Then, the second presentation information determination unit 509 selects, from among the displayed distance measuring point indexes and focusing frames, a distance measuring point index and a focusing frame, which are smallest in the distances between position p2 and the respective center positions of the distance measuring point index and focusing frame. As shown in the display screen 3520 illustrated in FIG. 35B, to highlight the selected distance measuring point index and focusing frame, the information presentation unit 510 changes a frame border 3501 from a solid line to a dotted line and displays the dotted line frame border 3501. Here, the method of highlighting can be a method of changing the color of the frame border 3501 or a method of changing the thickness of the frame border 3501 and only needs to be a method that enables the user to distinguish between the selected distance measuring point index and focusing frame and unselected distance measuring point indexes and focusing frames. Additionally, as shown in the display screen 3520 illustrated in FIG. 35B, the information presentation unit 510 can display a message 3502 for guiding the user in such a way as to prompt the user to gaze at the selected distance measuring point index and focusing frame in an edge of a screen of the display screen 3520. In this way, guiding the line of sight of the user to the selected distance measuring point index and focusing frame enables bringing the line of sight of the user closer to the index position in the second authentication registration data table 540 and thus enables increasing the quality of an authentication image in the second authentication. Moreover, highlighting a UI part for image capturing enables reducing a screen change occurring at the time of an image capturing operation for a subject image and thus enables preventing or reducing a hindrance in an image capturing operation for a subject image by the user.

Moreover, in a case where the display device 214 is displaying a grid of squares, the information presentation unit 510 can guide the user in such a way as to prompt the user to gaze at a grid square.

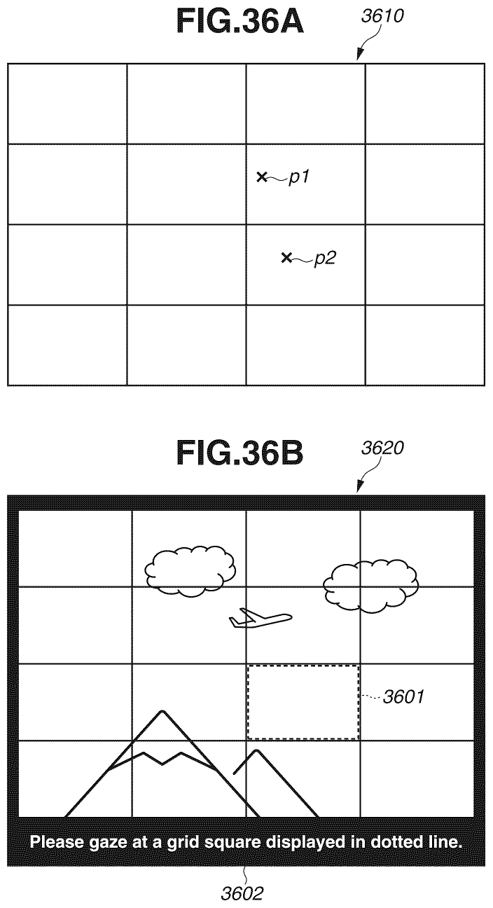

FIGS. 36A and 36B are diagrams illustrating examples of display screens 3610 and 3620, which are displayed in the display processing in step S3203 illustrated in FIG. 32 in modification example 2 of the second embodiment. Specifically, the second presentation information determination unit 509 obtains position p1 and position p2 shown in the screen 3610 illustrated in FIG. 36A with use of a method similar to the above-mentioned method in the second embodiment. Then, the second presentation information determination unit 509 selects, from among grid squares, a square that is smallest in the distances between position p2 and the respective center positions of the squares. As shown in the display screen 3620 illustrated in FIG. 36B, to highlight the selected grid square, the information presentation unit 510 changes a frame border 3601 from a solid line to a dotted line and displays the dotted line frame border 3601. Here, the method of highlighting can be a method of changing the color of the frame border 3601 or a method of changing the thickness of the frame border 3601 and only needs to be a method that enables the user to distinguish between the selected grid square and unselected grid squares. Additionally, as shown in the display screen 3620 illustrated in FIG. 36B, the information presentation unit 510 can display a message 3602 for guiding the user in such a way as to prompt the user to gaze at the selected grid square in an edge of a screen of the display screen 3620.

In this way, guiding the line of sight of the user to the selected grid square enables bringing the line of sight of the user closer to the index position in the second authentication registration data table 540 and thus enables increasing the quality of an authentication image in the second authentication. Moreover, highlighting a UI part for image capturing without adding a new UI part enables reducing a screen change occurring at the time of an image capturing operation for a subject image and thus enables preventing or reducing a hindrance in an image capturing operation for a subject image by the user.

According to modification example 2 of the second embodiment, guiding the line of sight of the user to a UI part for image capturing located closest to the line-of-sight position obtained at the time of registration enables bringing the line of sight of the user closer to the position thereof obtained at the time of registration and thus enables increasing the quality of an authentication image in the second authentication and increasing the accuracy of the second authentication. Moreover, without adding a new UI part, guiding the user in such a way as to prompt the user to gaze at a UI part for image capturing enables reducing a screen change occurring at the time of an image capturing operation for a subject image and thus enables increasing usability at the time of image capturing of a subject image.

### Modification Example 3 of Second Embodiment

If the position of the eye (eyeball) E of the user differs between the time of registration and the time of authentication, the authentication rate may decrease. In this respect, in modification example 3 of the second embodiment, a configuration is described in which guidance is performed in such a manner that, at the time of failure of authentication in the second authentication, the position of the eye (eyeball) E of the user becomes the same as that obtained at the time of registration in such a way as not to hinder an image capturing operation for a subject image by the user. Then, in modification example 3 of the second embodiment, while ensuring usability at the time of image capturing of a subject image, the configuration increases the quality of an authentication image in the second authentication and increases the authentication accuracy of the second authentication.

In the above-described second embodiment, in the processing operation for the time of failure of authentication in the second authentication, the eyeball state acquisition unit 507 acquires line-of-sight information as the current state of the eye (eyeball) E of the user, but also can acquire the position of the eye (eyeball) E of the user.

Specifically, in step S3202 illustrated in FIG. 32, the eyeball state acquisition unit 507 detects an eyeball by a known technical method from an eye image acquired by the eye image acquisition unit 501 and sets the coordinates of the center of the detected eyeball as current eyeball position coordinates C3. Moreover, the eyeball state acquisition unit 507 detects an eyeball by a similar method from each eye image in the second authentication registration data table 540 illustrated in FIG. 5D, and then selects, from among the respective center coordinates of the detected eyeballs, center coordinates that are smallest in distance between the center coordinates and the current eyeball position coordinates C3 and sets the selected center coordinates as registered eyeball position coordinates C4. Then, the eyeball state acquisition unit 507 can calculate the direction of a vector from the current eyeball position coordinates C3 to the registered eyeball position coordinates C4.

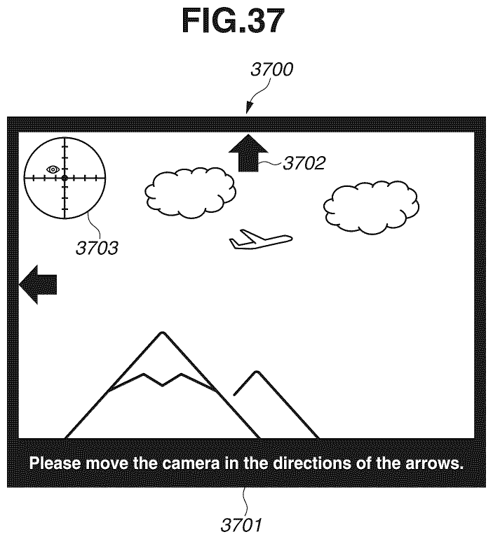

FIG. 37 is a diagram illustrating an example of a display screen 3700 for displaying guidance information included in the second presentation information in modification example 3 of the second embodiment. In step S3203 illustrated in FIG. 32, the second authentication unit 505 is able to display the display screen 3700 illustrated in FIG. 37 via the second presentation information determination unit 509 and the information presentation unit 510. Specifically, as shown in the display screen 3700 illustrated in FIG. 37, the second authentication unit 505 displays a message 3701 and an arrow 3702, which guide the eye access position of the user in the direction of the above-mentioned calculated vector, in an edge of a screen of the touch panel (operation member 123) or the display device 214. Additionally, as shown in the display screen 3700 illustrated in FIG. 37, the second authentication unit 505 displays an indicator 3703 that indicates the position of the eye (eyeball) E of the user in an edge of a screen of the touch panel (operation member 123) or the display device 214.

According to modification example 3 of the second embodiment, because it is possible to bring the position of the eye (eyeball) E of the user closer to the eyeball position obtained at the time of registration, it is possible to increase the quality of an authentication image in the second authentication and thus increase the accuracy of the second authentication. Moreover, displaying, in the edge of the screen, the second presentation information including guidance information for guiding the line of sight of the user enables preventing or reducing a hindrance occurring in an image capturing operation for a subject image by the user and thus enables increasing usability at the time of image capturing of a subject image.

### Modification Example 4 of Second Embodiment

If the eye access distance and eye access angle of the eye (eyeball) E of the user differ between the time of registration and the time of authentication, the authentication rate may decrease. In this respect, in modification example 4 of the second embodiment, a configuration is described in which guidance is performed in such a manner that, at the time of failure of authentication in the second authentication, the eye access distance and eye access angle of the eye (eyeball) E of the user become the same as those obtained at the time of registration in such a way as not to hinder an image capturing operation for a subject image by the user. In modification example 4 of the second embodiment, while ensuring usability at the time of image capturing of a subject image, this configuration increases the quality of an authentication image in the second authentication and thus increases the authentication accuracy of the second authentication.

In the above-described second embodiment, in the processing operation for the time of failure of authentication in the second authentication, the eyeball state acquisition unit 507 acquires line-of-sight information as the current state of the eye (eyeball) E of the user, but also can acquire the eye access distance and the eye access angle.

Specifically, in step S3202 illustrated in FIG. 32, the eyeball state acquisition unit 507 calculates the distance between the image capturing apparatus 100 and the eye (eyeball) E of the user as the current eye access distance with use of an output value of the eyepiece sensor 221. Moreover, the eyeball state acquisition unit 507 calculates the current eye access angle from the eye image acquired by the eye image acquisition unit 501 with use of, for example, a method described in Japanese Patent Laid-Open No. 2024-2562. Moreover, in step S611 illustrated in FIG. 6 for the registration processing, the eyeball state acquisition unit 507 calculates an eye access distance and an eye access angle, which correspond to the feature vector with use of a similar method, and preliminarily registers the calculated eye access distance and eye access angle with the second authentication registration data table 540. Then, the eyeball state acquisition unit 507 is able to calculate, from the current eye access distance and the eye access distance in the second authentication registration data table 540, a direction that brings the current eye access distance close to the eye access distance in the second authentication registration data table 540. Moreover, the eyeball state acquisition unit 507 is able to calculate, from the current eye access angle and the eye access angle in the second authentication registration data table 540, a direction that brings the current eye access angle close to the eye access angle in the second authentication registration data table 540.

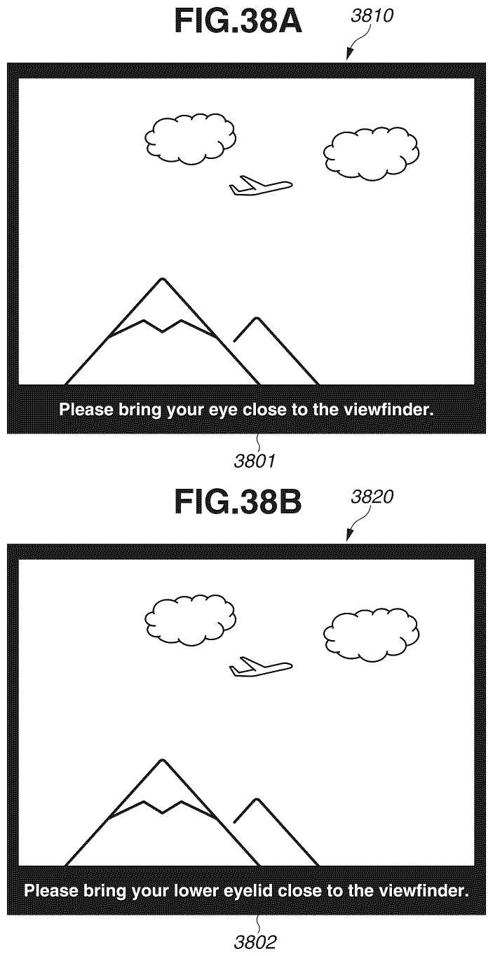

FIGS. 38A and 38B are diagrams illustrating examples of display screens 3810 and 3820 for displaying guidance information included in the second presentation information in modification example 4 of the second embodiment. In step S3203 illustrated in FIG. 32, the second authentication unit 505 is able to display the display screen 3810 illustrated in FIG. 38A and the display screen 3820 illustrated in FIG. 38B via the second presentation information determination unit 509 and the information presentation unit 510.

Specifically, as shown in the display screen 3810 illustrated in FIG. 38A, the second authentication unit 505 displays a message 3801 for guiding the eye access distance for the user in an edge of a screen of the touch panel (operation member 123) or the display device 214. By performing displaying as shown in the display screen 3810 illustrated in FIG. 38A, the second authentication unit 505 enables the user to adjust the eye access distance.

Moreover, as shown in the display screen 3820 illustrated in FIG. 38B, the second authentication unit 505 displays a message 3802 for prompting the user to adjust the eye access angle of the user in an edge of a screen of the touch panel (operation member 123) or the display device 214. By performing displaying as shown in the display screen 3820 illustrated in FIG. 38B, the second authentication unit 505 enables the user to adjust the eye access angle.

According to modification example 4 of the second embodiment, at the time of failure of authentication in the second authentication, it is possible to bring the eye access distance and eye access angle of the eye (eyeball) E of the user closer to those obtained at the time of registration and, thus, it is possible to increase the quality of an authentication image and increase the authentication accuracy of the second authentication. Moreover, displaying, in the edge of the screen, the second presentation information including guidance information for guiding the line of sight of the user enables preventing or reducing a hindrance occurring in an image capturing operation for a subject image by the user and thus enables increasing usability at the time of image capturing of a subject image.

### Modification Example 5 of Second Embodiment

If the wearing condition of eyewear such as eyeglasses or sunglasses by the user differs between the time of registration and the time of authentication, the authentication rate may decrease. In this respect, in modification example 5 of the second embodiment, a configuration is described in which guidance is performed in such a manner that, at the time of failure of authentication in the second authentication, the wearing condition of eyewear by the user becomes the same as that obtained at the time of registration in such a way as not to hinder an image capturing operation for a subject image by the user. In modification example 5 of the second embodiment, while ensuring usability at the time of image capturing of a subject image, this configuration increases the quality of an authentication image in the second authentication and thus increases the authentication accuracy of the second authentication.

In the above-described second embodiment, in the processing operation for the time of failure of authentication in the second authentication, the eyeball state acquisition unit 507 acquires line-of-sight information as the current state of the eye (eyeball) E of the user, but also can acquire the wearing condition of eyewear by the user.

Specifically, in step S3202 illustrated in FIG. 32, the eyeball state acquisition unit 507 determines a wearing condition E3 of eyewear by a known technical method from an eye image acquired by the eye image acquisition unit 501. Moreover, the eyeball state acquisition unit 507 determines a wearing condition E4 of eyewear by a similar method from the eye image in the second authentication registration data table 540 illustrated in FIG. 5D. Here, the eyeball state acquisition unit 507 can perform processing for determining the wearing condition E4 at the time of registration processing.

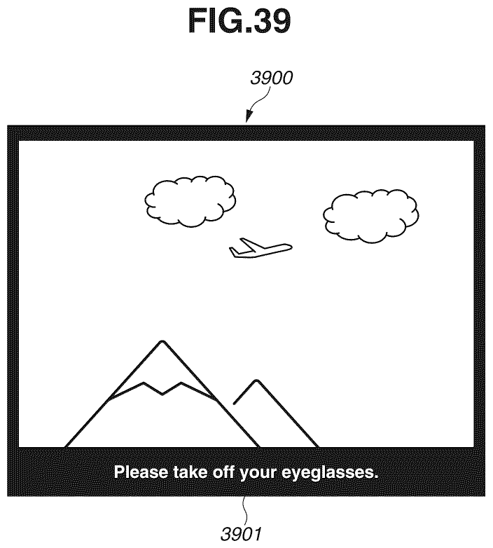

FIG. 39 is a diagram illustrating an example of a display screen 3900 for displaying guidance information included in the second presentation information in modification example 5 of the second embodiment. In step S3203 illustrated in FIG. 32, in a case where the wearing condition E3 and the wearing condition E4 are different from each other, the second authentication unit 505 is able to display the display screen 3900 illustrated in FIG. 39 via the second presentation information determination unit 509 and the information presentation unit 510. Specifically, as shown in the display screen 3900 illustrated in FIG. 39, the second authentication unit 505 displays a message 3901 that guides the user in such a manner that the wearing condition E3 and the wearing condition E4 become the same in an edge of a screen of the touch panel (operation member 123) or the display device 214. By performing displaying as shown in the display screen 3900 illustrated in FIG. 39, the second authentication unit 505 is able to bring the wearing condition of eyewear by the user close to that obtained at the time of registration and thus enables increasing the quality of an authentication image.

According to modification example 5 of the second embodiment, it is possible to perform guidance in such a manner that, for example, at the time of failure of authentication in the second authentication, the wearing condition of eyewear by the user becomes the same as that obtained at the time of registration and, thus, it is possible to increase the quality of an authentication image and increase the authentication accuracy of the second authentication. Moreover, displaying the second presentation information in an edge of a screen enables preventing or reducing a hindrance occurring in an image capturing operation for a subject image by the user and thus enables increasing usability at the time of image capturing of a subject image.

### Modification Example 6 of Second Embodiment

In modification example 6 of the second embodiment, a configuration is described in which the second authentication state is presented to the user by changing the color of a UI part for image capturing according to the second authentication state and thus increases usability at the time of image capturing of a subject image.

In the above-described second embodiment, a configuration has been described in which, in the second authentication processing, the second authentication unit 505 displays an authentication state with an icon via the second presentation information determination unit 509 and the information presentation unit 510.

In modification example 6 of the second embodiment, the second authentication unit 505 can change the color of at least one UI part for image capturing included in a focusing frame, a distance measuring point index, a grid square, characters representing an image capturing mode, or an icon representing an image capturing mode. In this case, the information presentation unit 510 can display, as the second presentation information, a UI with the color of the above-mentioned UI part for image capturing changed, according to at least one piece of information about the first authentication state or second authentication state in the authentication state table 550 managed by the authentication state management unit 506. Moreover, the information presentation unit 510 can display, as the first presentation information, a UI including at least one piece of information about the first authentication state or second authentication state in the authentication state table 550 managed by the authentication state management unit 506.

For example, in modification example 6 of the second embodiment, in step S1708 illustrated in FIG. 17, step S1902 illustrated in FIG. 19, and step S2002 illustrated in FIG. 20, the second authentication unit 505 causes the authentication state management unit 506 to update the second authentication state in the authentication state table 550 illustrated in FIG. 5E. At the same time, the second authentication unit 505 changes the color of a UI part to a color corresponding to the updated second authentication state and displays the UI part with the color thereof changed via the second presentation information determination unit 509 and the information presentation unit 510. Here, for example, the colors corresponding to the respective second authentication states are fixed and are assumed to be “unauthenticated: black,” “authentication failed: red,” and “authentication successful: green.” The colors that have been described here are merely examples and only need to be colors that enable the user to intuitively recognize a difference in the second authentication states. Moreover, a configuration in which the user is allowed to set colors that correspond to the respective second authentication states can be employed.

According to modification example 6 of the second embodiment, without adding a new UI part, changing the color of a UI part for image capturing enables reducing a screen change occurring at the time of an image capturing operation for a subject image. This enables preventing or reducing a hindrance in an image capturing operation for a subject image by the user and thus enables increasing usability at the time of image capturing of a subject image.

### Modification Example 7 of Second Embodiment

In modification example 7 of the second embodiment, a configuration is described in which, at the time of failure of authentication in the second authentication, an eyeball state score indicating a difference between the current state of the eye (eyeball) E and the state thereof obtained at the time of registration is presented to the user in such a way as not to hinder an image capturing operation for a subject image by the user. In modification example 7 of the second embodiment, while ensuring usability at the time of image capturing of a subject image, this configuration increases the effect of guiding the user and thus increases the authentication accuracy of the second authentication.

In the above-described second embodiment, in step S3202 illustrated in FIG. 32 in the second authentication processing, the eyeball state acquisition unit 507 acquires the current state of the eye (eyeball) E, but also can further acquire the above-mentioned eyeball state score.

For example, in a case where line-of-sight information is already acquired as the current state of the eye (eyeball) E of the user, when the above-mentioned eyeball state score is denoted by S2, the eyeball state acquisition unit 507 uses a function f2 of “S2=f2(D)” to acquire the eyeball state score S2. Here, the function f2 is a function that takes a higher value as the distance D is closer to 0 and that decreases in proportion to the distance D. Here, the function f2 can be defined by, for example, f2(D)=1/(D+ε). In this case, ε is a minute value for preventing division by zero. From the viewpoint of understandability, the eyeball state score S2 can be normalized in such a way as to be expressed within the range of 0 to 100. Furthermore, the function that is used for acquisition of the eyeball state score S2 is not limited to the above-mentioned function if the qualitative property thereof is unvarying. Moreover, the method of calculating the eyeball state score S2 is not limited to the method using the distance D but can be another method as long as it is a method that indicates a difference between the current state of the eye (eyeball) E of the user and the state thereof obtained at the time of registration.

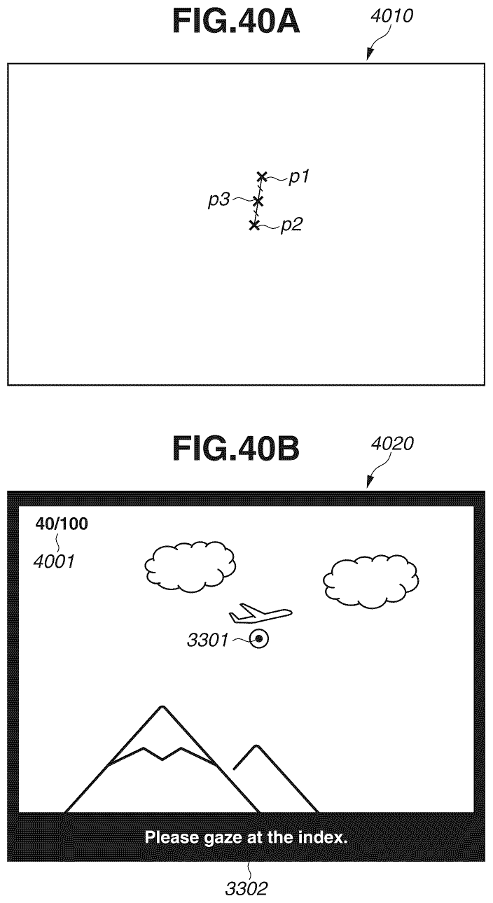

FIGS. 40A and 40B are diagrams illustrating examples of display screens 4010 and 4020 for displaying guidance information included in the second presentation information in modification example 7 of the second embodiment. In FIGS. 40A and 40B, the same constituent elements as the constituent elements illustrated in FIGS. 33A and 33B are assigned the respective same reference characters as those in FIGS. 33A and 33B and the detailed description thereof is omitted here. The display screen 4010 illustrated in FIG. 40A is the same as the display screen 3310 illustrated in FIG. 33A. In step S3203 illustrated in FIG. 32, the second authentication unit 505 is able to display the display screen 4020 illustrated in FIG. 40B via the second presentation information determination unit 509 and the information presentation unit 510.

Specifically, as shown in the display screen 4020 illustrated in FIG. 40B, the second authentication unit 505 displays an eyeball state score 4001 equivalent to the above-mentioned eyeball state score S2 in real time in an edge of a screen of the touch panel (operation member 123) or the display device 214.

According to modification example 7 of the second embodiment, because the user is able to intuitively adjust the line of sight of the eye (eyeball) E, it is possible to increase the quality of an authentication image and thus increase the authentication accuracy of the second authentication. Moreover, displaying the second presentation information including guidance information in an edge of a screen enables preventing or reducing a hindrance occurring in an image capturing operation for a subject image by the user and thus enables increasing usability at the time of image capturing of a subject image.

### Modification Example 8 of Second Embodiment

In modification example 8 of the second embodiment, a configuration is described in which, at the time of the second authentication, the user is caused to recognize that the photographer cannot be identified by presenting information corresponding to the first authentication state to the user, and thus increases usability.

In step S1708 illustrated in FIG. 17 in the second authentication processing, the second authentication unit 505 can update displaying according to the first authentication state that the authentication state management unit 506 manages, via the second presentation information determination unit 509 and the information presentation unit 510.

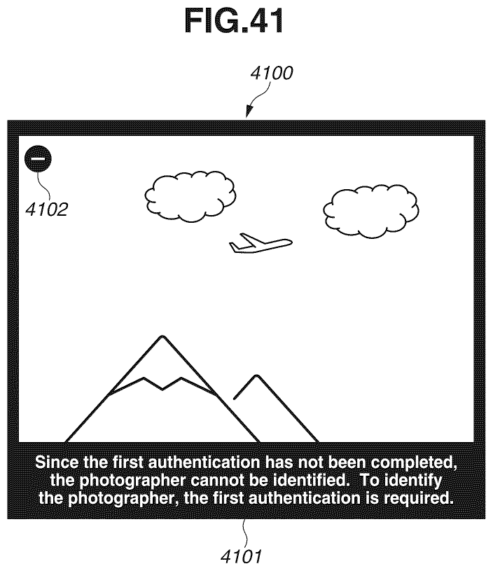

FIG. 41 is a diagram illustrating an example of a display screen 4100 for displaying second presentation information in modification example 8 of the second embodiment. In a case where the first authentication state that the authentication state management unit 506 manages is “unauthenticated” or “authentication failed,” the second authentication unit 505 displays a message 4101 shown in the display screen 4100 illustrated in FIG. 41, via the second presentation information determination unit 509 and the information presentation unit 510. Specifically, the information presentation unit 510 displays, as the message 4101, first information indicating that the first authentication state is “unauthenticated” (or “authentication failed”), second information indicating that the photographer cannot be identified, and third information indicating that, to identify the photographer, the first authentication is required. Furthermore, in modification example 8 of the second embodiment, a configuration can be employed in which the information presentation unit 510 displays at least one of the first information, second information, or third information mentioned above. Additionally, the information presentation unit 510 displays, in the display screen 4100 illustrated in FIG. 41, an icon 4102 indicating that the first authentication state is “unauthenticated” or “authentication failed.” In this case, as shown in the display screen 4100 illustrated in FIG. 41, the information presentation unit 510 displays the message 4101 and the icon 4102 in edges of a screen of the touch panel (operation member 123) or the display device 214.

Thus, in modification example 8 of the second embodiment, as illustrated in FIG. 41, the second presentation information determination unit 509 determines the second presentation information based on the authentication state of the first authentication unit 504, and the information presentation unit 510 presents the second presentation information based on the authentication state of the first authentication unit 504.

According to modification example 8 of the second embodiment, it is possible to cause the user to recognize that the photographer cannot be identified. Additionally, displaying the message 4101 and the icon 4102 in the edge of the screen of the touch panel (operation member 123) or the display device 214 enables preventing or reducing a hindrance in an image capturing operation for a subject image by the user. This enables increasing usability at the time of image capturing of a subject image.

### Other Embodiments

The present disclosure can also be implemented by processing for supplying a program for implementing one or more functions of the above-described embodiments to a system or apparatus via a network or a storage medium and causing one or more processors included in a computer of the system or apparatus to read out and execute the program. Moreover, the present disclosure can also be implemented in combination with a circuit that implements one or more functions of the above-described embodiments (for example, an application specific integrated circuit (ASIC)).

The program and a non-transitory computer-readable storage medium storing the program are included in the present disclosure. Moreover, the present disclosure can be embodied as, for example, the above-described system, apparatus, method, program, or storage medium. For example, the present disclosure can be applied to a system configured with a plurality of pieces of equipment or can be applied to an apparatus configured with a single piece of equipment.

Furthermore, the above-described embodiments of the present disclosure are merely nothing more than those representing examples of concretization in implementing the present disclosure, and these should not be construed to limit the technical scope of the present disclosure. Thus, the present disclosure can be implemented in various forms without departing from the technical idea thereof or the principal features thereof.

According to an aspect of the present disclosure, it is possible to acquire an authentication image in such a manner that reduces a change in appearance between the authentication image and a registered image while ensuring usability at the time of image capturing using an image capturing apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-179992 filed Oct. 15, 2024, the entirety of which is incorporated herein by reference.

What is claimed is:

1. An image capturing apparatus comprising:
at least one processor; and
at least one memory having stored thereon instructions, which, when executed by the at least one processor, cause the image capturing apparatus to:
capture a subject image based on an operation performed by a user;
capture an eye image including an eye of the user as an authentication image;
perform authentication of the user based on the eye image before capturing of the subject image;
perform authentication of the user based on the eye image during capturing of the subject image;
present, to the user, first presentation information including guidance information for guiding at least one of a position or direction of the eye of the user during capturing of the eye image when authentication of the user is performed before capturing of the subject image; and
present, to the user, during capturing of the eye image, second presentation information related to authentication processing for the user when authentication of the user is performed during capturing of the subject image.

2. The image capturing apparatus according to claim 1, wherein the second presentation information is presentation information different than the first presentation information.

3. The image capturing apparatus according to claim 1, wherein the second presentation information is presentation information including guidance information.

4. The image capturing apparatus according to claim 1, wherein the instructions, when executed by the at least one processor, cause the image capturing apparatus further to:
determine the first presentation information; and
determine the second presentation information.

5. The image capturing apparatus according to claim 4, wherein the instructions, when executed by the at least one processor, cause the image capturing apparatus further to:
in a case where a number of consecutive failures of authentication of the user before capturing of the subject image is greater than or equal to a first threshold value, terminate authentication processing for the user;
determine the first presentation information including information indicating terminating authentication processing for the user in a case where the number of consecutive failures of authentication of the user before capturing of the subject image is greater than or equal to the first threshold value;
in a case where a number of consecutive failures of authentication of the user during capturing of the subject image is greater than or equal to a second threshold value, terminate authentication processing for the user; and
determine the second presentation information including information indicating terminating authentication processing for the user in a case where the number of consecutive failures of authentication of the user during capturing of the subject image is greater than or equal to the second threshold value.

6. The image capturing apparatus according to claim 5, wherein the second threshold value is a value smaller than the first threshold value.

7. The image capturing apparatus according to claim 4, wherein the instructions, when executed by the at least one processor, cause the image capturing apparatus further to:
acquire a current state of the eye of the user;
determine the first presentation information based on the current state of the eye of the user; and
determine the second presentation information based on the current state of the eye of the user.

8. The image capturing apparatus according to claim 7, further comprising a line-of-sight sensor configured to acquire line-of-sight information about the user as the current state of the eye of the user,
wherein the instructions, when executed by the at least one processor, cause the image capturing apparatus further to:
determine the first presentation information based on the line-of-sight information acquired by the line-of-sight sensor; and
determine the second presentation information based on the line-of-sight information acquired by the line-of-sight sensor.

9. The image capturing apparatus according to claim 7, further comprising an eye access sensor configured to acquire eye access information about the user as the current state of the eye of the user,
wherein the instructions, when executed by the at least one processor, cause the image capturing apparatus further to:
determine the first presentation information based on the eye access information acquired by the eye access sensor; and
determine the second presentation information based on the eye access information acquired by the eye access sensor.

10. The image capturing apparatus according to claim 7,
wherein the instructions, when executed by the at least one processor, cause the image capturing apparatus further to:
determine the guidance information included in the first presentation information based on the current state of the eye of the user before authentication processing for the user, which is performed before capturing of the subject image; and
not determine the guidance information as the second presentation information before authentication processing for the user, which is performed during capturing of the subject image.

11. The image capturing apparatus according to claim 4, wherein the instructions, when executed by the at least one processor, cause the image capturing apparatus further to:
manage a preliminarily acquired registered eye image of the user and line-of-sight information about the user obtained during acquisition of the registered eye image;
determine the guidance information included in the first presentation information based on the line-of-sight information; and
determine guidance information to be included in the second presentation information based on the line-of-sight information and a current position of a focusing frame.

12. The image capturing apparatus according to claim 4, wherein the instructions, when executed by the at least one processor, cause the image capturing apparatus further to determine the second presentation information based on an authentication state obtained before capturing of the subject image.

13. The image capturing apparatus according to claim 12, wherein the instructions, when executed by the at least one processor, cause the image capturing apparatus further to, in a case where the authentication state obtained before capturing of the subject image indicates unauthenticated or authentication failed, determine the second presentation information from among at least information about the authentication state, information indicating that the user cannot be identified, or information indicating that, to identify the user, authentication is required.

14. The image capturing apparatus according to claim 1, wherein the instructions, when executed by the at least one processor, cause the image capturing apparatus further to display the first presentation information and the second presentation information.

15. The image capturing apparatus according to claim 14, further comprising, as a display unit, at least one of a display device located inside a viewfinder included in the image capturing apparatus or a back side display included in the image capturing apparatus,
wherein the instructions, when executed by the at least one processor, cause the image capturing apparatus further to:
display the first presentation information at any position in a screen of the display unit as a user interface (UI); and
display the second presentation information at a position in an edge of a screen of the display unit as a UI.

16. The image capturing apparatus according to claim 15, wherein, when displaying the second presentation information at the position in the edge of the screen as the UI, the display unit is displaying the subject image in the screen.

17. The image capturing apparatus according to claim 15, wherein the instructions, when executed by the at least one processor, cause the image capturing apparatus further to:
display, as the first presentation information, the UI including at least one of an authentication state obtained before capturing of the subject image or an authentication state obtained during capturing of the subject image; and
display, as the second presentation information, the UI obtained by changing a color of at least one of a focusing frame, a distance measuring point index, a grid square, characters representing an image capturing mode, or an icon representing an image capturing mode according to at least one of the authentication state obtained before capturing of the subject image or the authentication state obtained during capturing of the subject image.

18. The image capturing apparatus according to claim 15, wherein the instructions, when executed by the at least one processor, cause the image capturing apparatus further to:
acquire a current state of the eye of the user;
display, as the first presentation information, the UI including the guidance information based on the current state of the eye of the user acquired in a case where an authentication state obtained before capturing of the subject image indicates authentication failed; and
display, as the second presentation information, the UI including guidance information for guiding the user in such a way as to prompt the user to gaze at at least one of a focusing frame, a distance measuring point index, or a grid square based on the current state of the eye of the user acquired in a case where an authentication state obtained during capturing of the subject image indicates authentication failed.

19. A control method for an image capturing apparatus including a first image capturing unit configured to capture a subject image based on an operation performed by a user and a second image capturing unit configured to capture an eye image including an eye of the user as an authentication image, the control method comprising:
performing authentication of the user based on the eye image obtained by the second image capturing unit before capturing of the subject image by the first image capturing unit;
performing authentication of the user based on the eye image obtained by the second image capturing unit during capturing of the subject image by the first image capturing unit;
presenting, to the user, first presentation information including guidance information for guiding at least one of a position or direction of the eye of the user during capturing of the eye image by the second image capturing unit when authentication of the user is performed before capturing of the subject image by the first image capturing unit; and
presenting, to the user, during capturing of the eye image, second presentation information related to authentication processing for the user when authentication of the user is performed during capturing of the subject image by the first image capturing unit.

20. A non-transitory computer-readable storage medium storing instructions that, when executed by a computer, cause the computer to perform a control method for an image capturing apparatus including a first image capturing unit configured to capture a subject image based on an operation performed by a user and a second image capturing unit configured to capture an eye image including an eye of the user as an authentication image, the control method comprising:
performing authentication of the user based on the eye image obtained by the second image capturing unit before capturing of the subject image by the first image capturing unit;
performing authentication of the user based on the eye image obtained by the second image capturing unit during capturing of the subject image by the first image capturing unit;
presenting, to the user, first presentation information including guidance information for guiding at least one of a position or direction of the eye of the user during capturing of the eye image by the second image capturing unit when authentication of the user is performed before capturing of the subject image by the first image capturing unit; and
presenting, to the user, during capturing of the eye image, second presentation information related to authentication processing for the user when authentication of the user is performed during capturing of the subject image by the first image capturing unit.
